(19) United States
(12) Patent Application Publication
(10) Pub. No.: US 2002/0004686 A1
(43) Pub. Date: Jan. 10, 2002

(54) Apparatus, method, program, and data structure for assisting placing order for manufacturing semiconductor device

(75) Inventor: Tsutomu Chiba, Sagamihara-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Kawasaki-shi (JP)

(21) Appl. No.: 09/893,663

(22) Filed: Jun. 29, 2001

(30) Foreign Application Priority Data
Jun. 30, 2000 (JP) 2000-199372

(51) Int. Cl. G06F 19/00; G06F 17/60

(52) U.S. Cl. 700/97; 700/99; 700/116; 700/117; 700/121; 705/37

(57) ABSTRACT

A method assists a semiconductor device developer to place an order for manufacturing a semiconductor device to specialized makers of different categories. The method asks a first maker to clarify a category of semiconductor device manufacture to which the first maker belongs. The method asks the first maker to select makers of other categories of semiconductor device manufacture with which the first maker wants to be interfaced. The method asks the makers concerned to fabricate a sample semiconductor device to confirm interfaces among the makers, and if the interfaces are confirmed, registers the makers as an interfaced maker group. The method asks the semiconductor device developer to enter the specifications of a semiconductor device developed by the developer. According to the specifications, the method retrieves maker groups and proposes to the developer the retrieved maker groups as proper maker groups capable of manufacturing the semiconductor device developed by the developer.

CROSS REFERENCE TO RELATED APPLICATIONS

This application is based upon and claims the benefit of priority from the prior Japanese Patent Application No. P2000-199372, filed on May 30, 2000; the entire contents of which are incorporated herein by reference.

### BACKGROUND OF THE INVENTION

1. Field of the Invention

The present invention relates to a method of assisting the placing and receiving of an order for manufacturing semiconductor devices such as ASICs (application specific ICs) through a computer network, and an apparatus, a program, and a data structure related to the method.

2. Description of the Related Art

When developing a semiconductor device such as an ASIC, a semiconductor device developer studies specifications, cost, schedule, etc., related to the device in advance, determines makers, and starts materializing the device.

After determining makers, the developer must study design environments and techniques characteristic to the makers. This study needs extended time and labor, and due to this, it is hard for the developer to reconsider the makers when corrections arise in the specifications and schedule of the device. This circumstance forces the developer to carefully select makers and increases the developer's risk.

Conventionally, a developer chooses a general LSI maker who carries out designing to testing of a semiconductor device. The general LSI maker asks specialized makers such as electronic design automation (EDA) tool makers, silicon foundries, assemblers, etc., to produce a required semiconductor device. Developers have no chance to choose such specialized makers directly or through general LSI makers. The general LSI makers choose specialized makers that fit to their convenience. It is difficult for the developers to select specialized makers having latest manufacturing technology.

### SUMMARY OF THE INVENTION

The present invention provides a method of assisting the placing, managing, and receiving of an order for manufacturing a semiconductor device. The present invention also provides an apparatus, a program, and a data structure related to the method.

The present invention provides an apparatus for assisting the placing of an order for manufacturing a semiconductor device, having a maker registering unit for registering makers that are interfaced to one another and a maker introducing unit for introducing interfaced makers.

The maker registering unit includes a maker organizing unit for organizing groups of makers in specialized categories to manufacture semiconductor devices, an interface confirming unit for confirming interfaces among the makers, and a maker recording unit for recording groups of the interfaced makers.

The maker introducing unit includes a maker retrieving unit for retrieving maker groups that are capable of manufacturing a semiconductor device of given specifications.

Other and further objects and features of the present invention will become obvious upon an understanding of the illustrative embodiments about to be described in connection with the accompanying drawings or will be indicated in the appended claims, and various advantages not referred to herein will occur to one skilled in the art upon employing of the invention in practice.

### BRIEF DESCRIPTION OF THE SEVERAL VIEWS OF THE DRAWINGS

FIG. 1 is a flowchart showing semiconductor device manufacture through makers in specialized categories and maker-to-maker interfaces;

FIG. 2 shows an example of a computer network with which a method of assisting the placing of an order for manufacturing a semiconductor device according to the present invention is achieved;

FIG. 3 shows an illustrative structure of a server 1 included in the network of FIG. 2;

FIG. 4 shows essential parts of a controller 21 in the server of FIG. 3;

FIG. 5 shows essential parts of a main program 29 in the server of FIG. 3;

FIG. 6 shows essential parts of one of computers 3 to 11 in the network of FIG. 2, these computers being operated by semiconductor device makers;

FIG. 7 shows essential parts of one of computers 12 to 16 in the network of FIG. 2, these computers being operated by semiconductor device developers;

FIG. 8 shows an essential data structure of a maker file in storage 25 and 55 of FIGS. 3 and 6;

FIG. 9 shows an essential data structure of an interface file in storage 26 of FIG. 3;

FIG. 10 shows an essential data structure of a developer file in storage 27 of FIG. 3;

FIG. 11 is a flowchart showing maker registering steps;

FIGS. 12 and 13 are flowcharts showing maker introducing steps;

FIG. 14 shows an example of a screen display at a developer or a maker;

FIGS. 15 to 19 show examples of screen displays at a maker;

FIGS. 20 to 22 show examples of screen displays for maker registration; and

FIGS. 23 to 35 show examples of screen displays at a developer.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

Maker interface

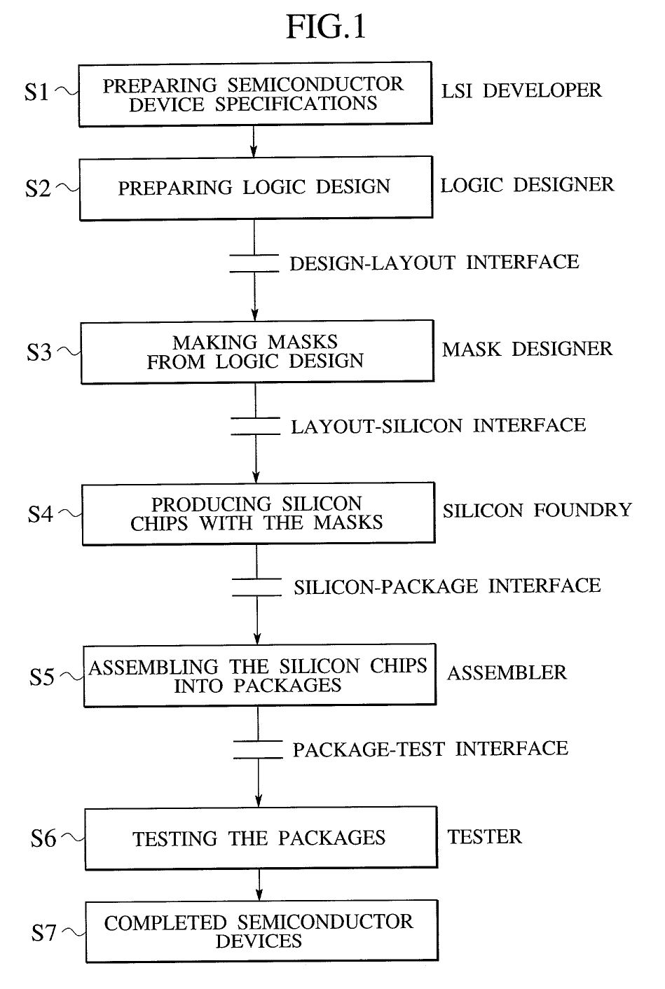

Semiconductor device manufacturing steps will briefly be studied with reference to FIG. 1. These steps are carried out at specialized makers to produce a semiconductor device.

In step S1, a semiconductor device developer prepares the specifications of a semiconductor device to develop. In step S2, a logic designer prepares a logic design for the semiconductor device according to the specifications. In step S3, a mask designer prepares masks according to the logic design.

In step S4, a silicon foundry produces a silicon chip with the masks. In step S5, an assembler assembles the silicon chip into a package. In step S6, a tester tests the package. In step S7, the semiconductor device the developer desired is complete.

Between the logic designer of step S2 and the mask designer of step S3, there is a design-layout interface. The “interface” is an environment or a connection through which an intermediate result (such as logic circuit data provided by the logic designer) is handed over from one maker to another in the semiconductor device manufacturing flow. The interface enables a maker to smoothly receive and process an intermediate result from a maker in the preceding step. An intermediate result handled by the design-layout interface is logic circuit data that must be prepared so as to make the mask designer properly prepare a layout of masks.

Between the mask designer of step S3 and the silicon foundry of step S4, there is a layout-silicon interface. This interface handles photomasks as an intermediate result. The photomasks must be produced so that they are usable to make silicon chips from a silicon wafer. For example, the photomasks must keep processible minimum dimensions for wafers.

Between the silicon foundry of step S4 and the assembler of step S5, there is a silicon-package interface. This interface handles silicon chips as an intermediate result. The silicon chips must be produced so that they may properly be packaged. For example, pad intervals on a silicon chip must keep minimum intervals for bonding wires.

Between the assembler of step S5 and the tester of step S6, there is a package-test interface. This interface involves semiconductor devices provided by the assembler and the logic circuit data provided by the logic designer. The semiconductor devices must be packaged to secure intended operations. For example, pins formed on a package must agree with sockets on a test board.

These four interfaces are essential to fabricate a semiconductor device. Without any one of the interfaces, the semiconductor manufacturing steps will not smoothly advance and will cause trouble in finished products due to inconsistency among the steps.

The logic designer, mask maker, silicon foundry, assembler, and tester may be separate makers specialized in their categories. If there is no general LSI maker mediating between such makers, one may form maker groups each involving the four interfaces mentioned above to enable a semiconductor device developer to select one of the maker groups and ask the selected maker group to manufacture a semiconductor device developed by the developer.

System for platform provider to assist placing of order for manufacturing semiconductor device

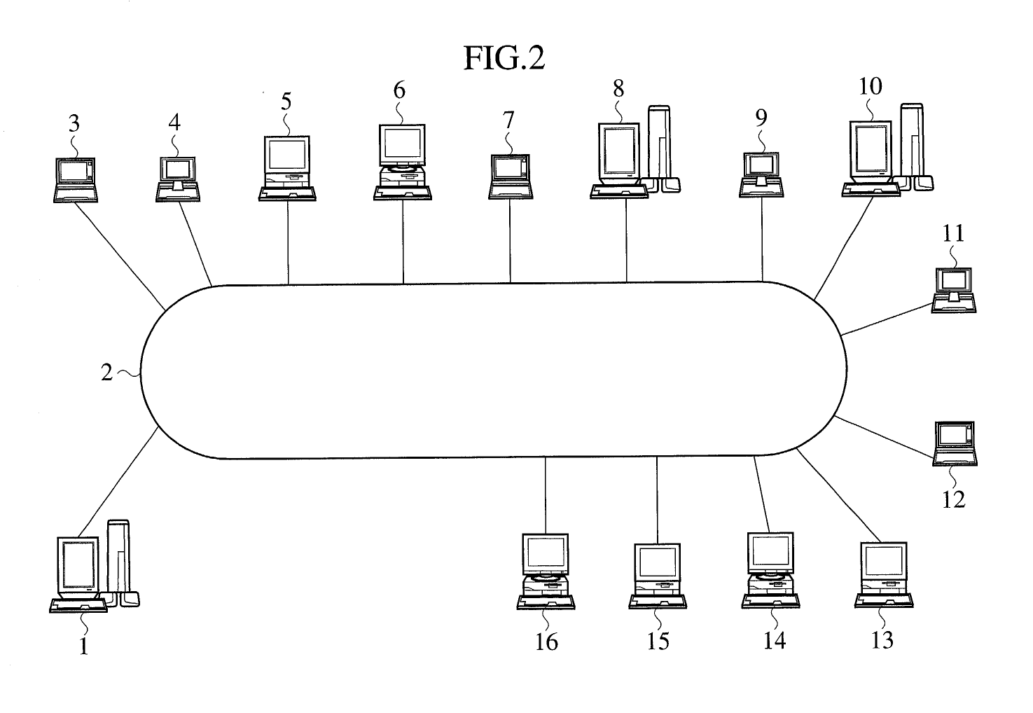

FIG. 2 shows an example of a computer network with which a method of assisting the placing of an order for manufacturing a semiconductor device according to an embodiment of the present invention is achieved. The network 2 includes a server 1 and terminal computers 3 to 16, the server and computers being connected to the network 2 through telephone lines.

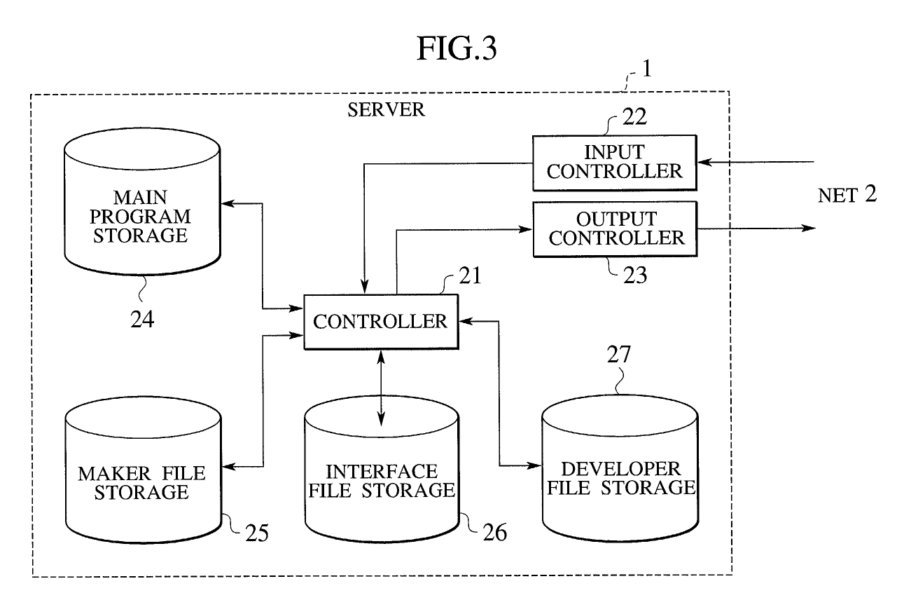

FIG. 3 shows an illustrative structure of the server 1 controlled by a platform provider. The “platform provider” is one who mediates between a semiconductor device developer and semiconductor device makers in specialized categories. The server 1 includes a controller 21, an input controller 22 connected to the controller 21 and network 2, an output controller 23 connected to the controller 21 and the network 2, main program storage 24 connected to the controller 21, maker file storage 25 connected to the controller 21, interface file storage 26 connected to the controller 21, and developer file storage 27 connected to the controller 21. The controller 21 may be a central processing unit (CPU) to read a main program from the storage 24 and control the storage 24 to 27 and controllers 22 and 23.

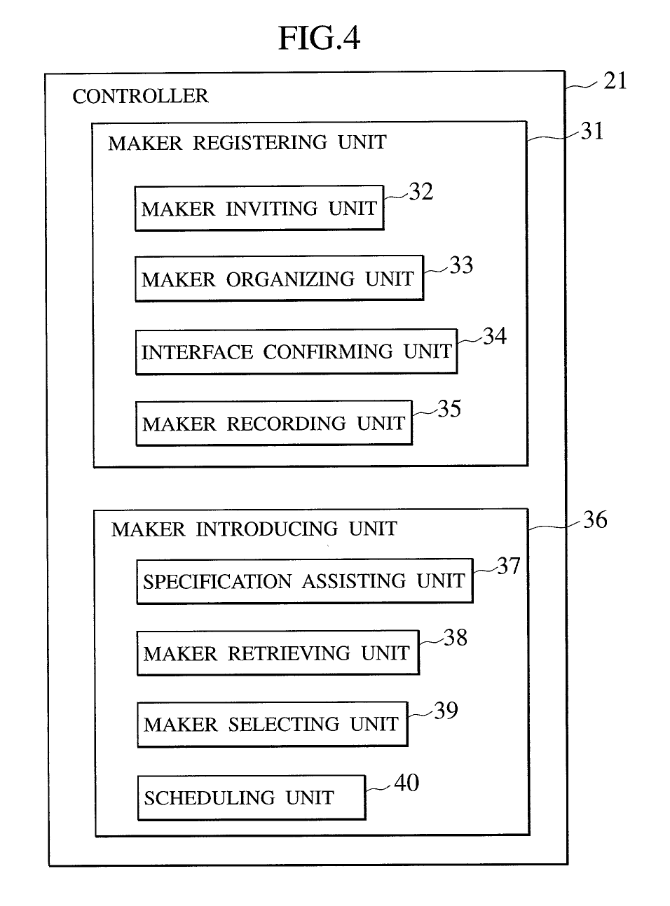

FIG. 4 shows essential parts in the controller 21. The controller 21 includes a maker registering unit 31 for registering interfaced makers and a maker introducing unit 36 for introducing interfaced makers. The maker registering unit 31 includes a maker inviting unit 32, a maker organizing unit 33, an interface confirming unit 34, and a maker recording unit 35. The maker introducing unit 36 includes a specification assisting unit 37, a maker retrieving unit 38, a maker selecting unit 39, and a scheduling unit 40 for determining delivery dates.

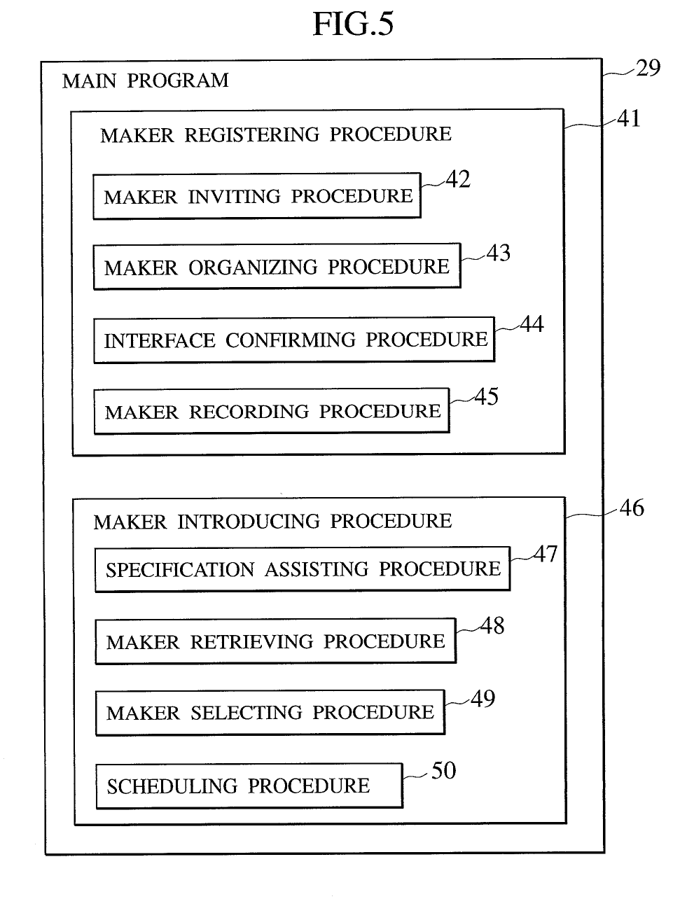

FIG. 5 shows essential parts in a main program 29 stored in the storage 24. The main program 29 includes a maker registering procedure 41 for registering interfaced makers and a maker introducing procedure 46 for introducing interfaced makers. The maker registering procedure 41 includes a maker inviting procedure 42, a maker organizing procedure 43, an interface confirming procedure 44, and a maker recording procedure 45. The maker introducing procedure 46 includes a specification assisting procedure 47, a maker retrieving procedure 48, a maker selecting procedure 49, and a scheduling procedure 50 for determining delivery dates.

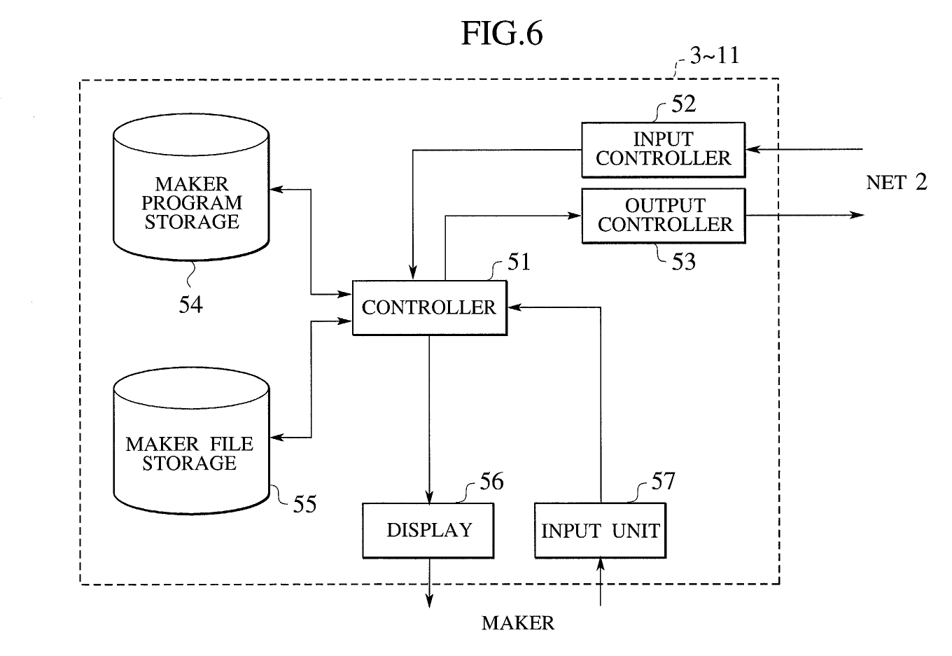

FIG. 6 shows essential parts in one of the computers 3 to 11 operated by semiconductor device makers. The computer includes a controller 51, an input controller 52 connected to the controller 51 and network 2, an output controller 53 connected to the controller 51 and network 2, maker program storage 54 connected to the controller 51, maker file storage 55 connected to the controller 51, a display 56 connected to the controller 51, and an input unit 57 connected to the controller 51.

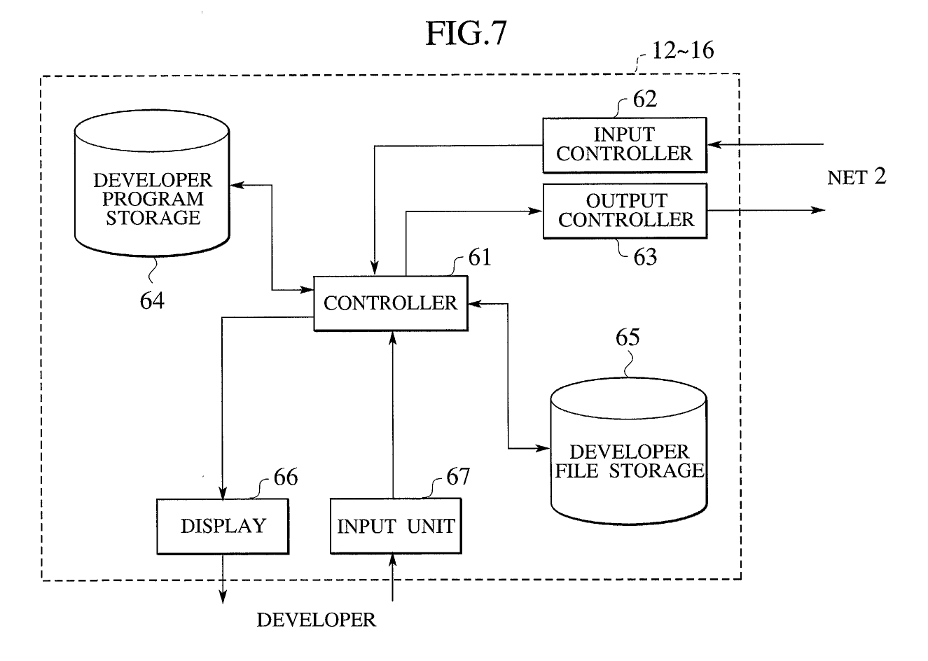

FIG. 7 shows essential parts in one of the computers 12 to 16 operated by semiconductor device developers. The computer includes a controller 61, an input controller 62 connected to the controller 61 and network 2, an output controller 63 connected to the controller 61 and network 2, maker program storage 64 connected to the controller 61, developer file storage 65 connected to the controller 61, a display 66 connected to the controller 61, and an input unit 67 connected to the controller 61.

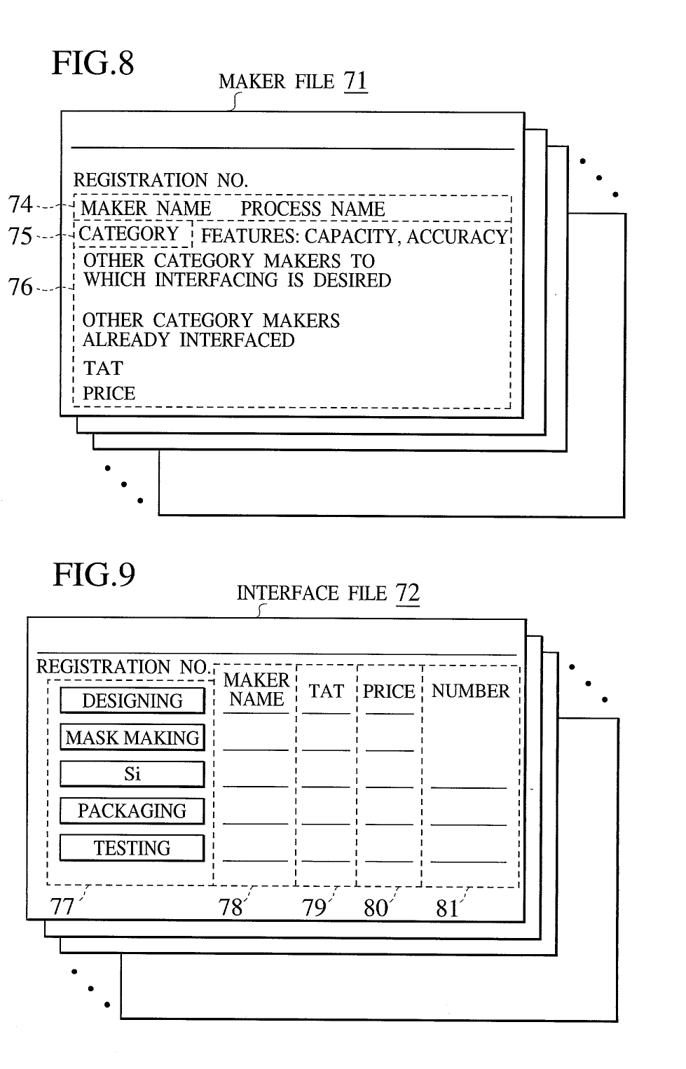

FIG. 8 shows an essential data structure of a maker file 71 stored in the storage 25 and 55. The maker file 71 includes an area 74 to store the name of a maker, the name of a semiconductor device manufacturing process proposed by the maker, and labels to identify these pieces of data. The maker file 71 is prepared for each maker and contains a maker name, a registration number, a category such as a logic designer or a tester, and features of the maker. The category is recorded in an area 75 in the file 71. The features are recorded in an area 76 in the file 71. The features include, for example, the performance and accuracy of the maker's manufacturing process, names of makers with which the maker in question desires to be interfaced, names of makers already interfaced with the maker in question, a turnaround time (TAT) of the maker's manufacturing process, and a price charged by the maker. The area 74 is related to the areas 75 and 76 so that data in the maker files 71 may be displayed as a list.

FIG. 9 shows an essential data structure of an interface file 72 stored in the storage 26. The interface file 72 keeps a registration number, a group of makers who previously manufactured a semiconductor device, and categories to which the makers belong. The interface file 72 has an area 77 for categories. Each category is related to a maker name and performance indexes. The performance indexes include TATs, unit prices, and numbers and are kept in areas 78, 79, 80, and 81 in the interface file 72. The maker name area 78 is related to the category area 77 so that maker names are related to categories, respectively. To relate maker names with performance indexes, the maker name area 78 is related to the index areas 79 to 81. The interface file 72 may contain total prices charged to developers.

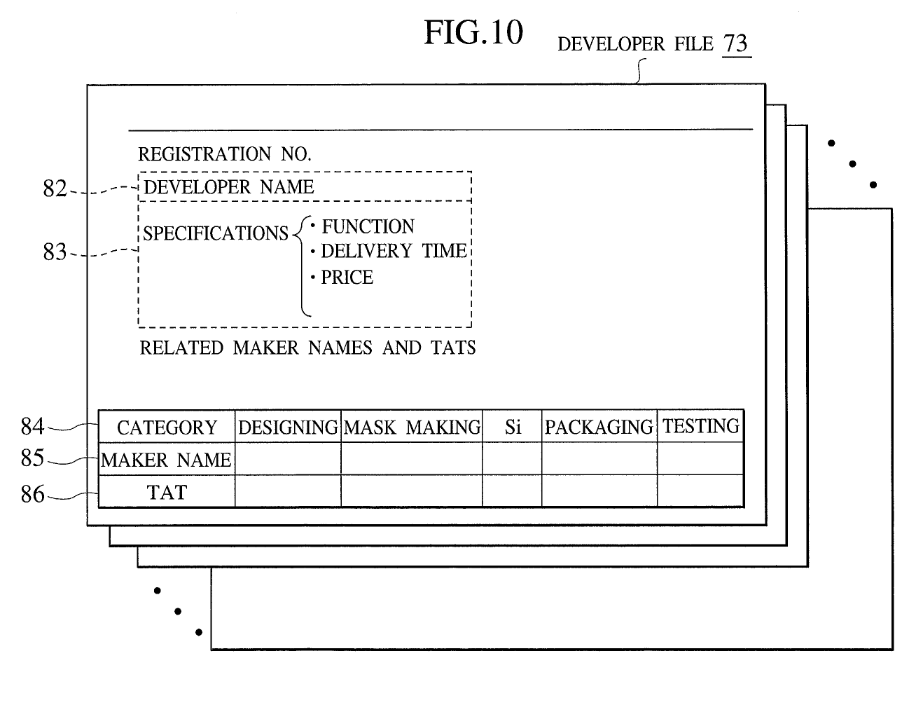

FIG. 10 shows an essential data structure of a developer file 73 stored in the storage 27 and 65. The developer file 73 keeps a developer registration number, a developer name, the functions, delivery data, price, specifications of a semiconductor device manufactured or to be manufactured, and the names and TATs (turnaround times) of makers related to the manufacturing of the semiconductor device. The developer file 73 has an area 82 for recording a developer name, the name of a semiconductor device developed by the developer, and related labels. The developer file 73 also has an area 83 for keeping specifications, an area 84 for keeping categories, an area 85 for keeping maker names, and an area 86 for keeping TATs. The developer name area 82 is related to the specification area 83 so that the specifications may be listed in connection with the developer name. The maker name area 85 is related to the category area 84, to relate categories to maker names, respectively. The maker name area 85 is related to the TAT area 86, to relate maker names to TATs, respectively.

The maker names in the developer file 73 may be equal to those in the interface file 72. The developer file 73 contains the developer name, specifications, etc., that must be confidential. Accordingly, the interface file 72 is prepared by extracting not-confidential data from the developer file 73, so that the interface file 72 may be disclosed to every developer.

Steps taking place among platform provider, developer, and makers

Steps carried out by a platform provider, a semiconductor device developer, and a group of categorized semiconductor makers will be explained according to the present invention. The platform provider mediates between the developer and the makers through the computer network 2.

First, the steps carried out by a platform provider will be explained. The platform provider uses the computer network 2 to assist a developer to develop and manufacture a semiconductor device. The steps carried out by the platform provider include inviting makers who want to manufacture semiconductor devices in collaboration with registered makers of other categories, and introducing registered makers to developers who want to develop and manufacture specific semiconductor devices. In this specification, the “maker” is any firm or person classified into one of semiconductor device manufacturing categories including logic designing, mask making, silicon foundry, chip assembling, packaging, and testing. The makers are represented with names, labels, or registration numbers that are stored in, for example, the storage 25 connected to the network 2. The categories into which the makers are classified are not limited to those shown in FIG. 1. Any type of classification is applicable to the present invention. For example, the logic designing and mask making may be classified into one category, or the mask making may be classified into mask designing and mask production.

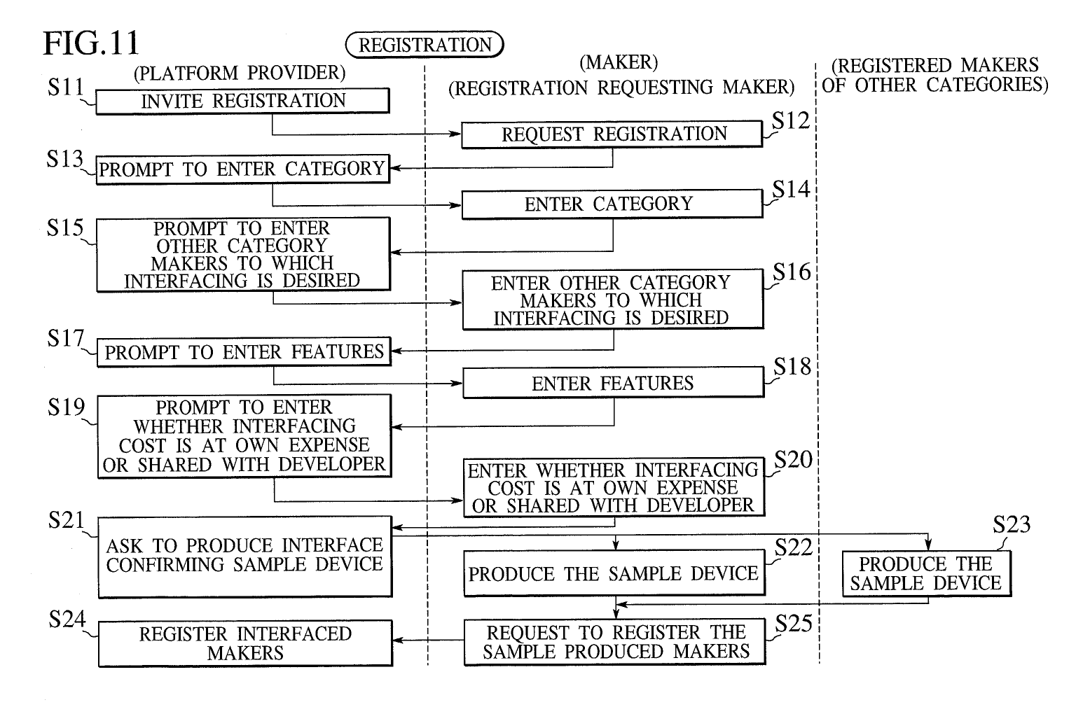

The maker registering step according to the present invention will be explained with reference to FIG. 11. This step is carried out by the maker inviting unit 32 of FIG. 4 according to the maker inviting procedure 42 of FIG. 5. In step S11 of FIG. 11, the platform provider invites, through the network 2, makers who want to be registered.

In step S12 of FIG. 11, a maker requests registration. In response to the request, the platform provider asks, in step S13, the maker to select a category to which the maker belongs. At this time, the maker organizing unit 33 of FIG. 4 starts the maker organizing procedure 43 of FIG. 5.

In step S14 of FIG. 11, the maker enters a category to which the maker belongs. In step S15, the platform provider prompts the maker to enter makers of other categories with which the maker wants to be interfaced, i.e., with which the maker wants to manufacture a semiconductor device in collaboration. At this time, the maker is asked to enter one maker for one category.

In step S16, the maker enters makers with which the maker in question wants to be interfaced. In step S17, the platform provider asks the maker to enter products, techniques, features, etc., specific to the maker. In step S18, the maker enters features, etc., specific to the maker. At this time, the maker organizing unit 33 of FIG. 4 terminates the maker organizing procedure 43 of FIG. 5.

In step S19, the platform provider prompts the maker to determine whether an interfacing cost is at the maker's own expense or is shared with a developer. At this time, the interface confirming unit 34 of FIG. 4 starts the interface confirming procedure 44 of FIG. 5.

In step S20 of FIG. 11, the maker determines who bears the interfacing cost. In step S21, the platform provider asks the maker in question and the makers with which the maker in question wants to be interfaced to produce a sample semiconductor device used to confirm the correctness of interfaces among the makers. The sample may be the semiconductor device requested by the developer. At this moment, the interface confirming unit 34 of FIG. 4 terminates the interface confirming procedure 44 of FIG. 5.

In steps S22 and S23 of FIG. 11, the makers fabricate the sample semiconductor device. If the sample produced by the makers is verified to operate as specified, the makers are admitted as an interfaced maker group that is capable of manufacturing the semiconductor device in collaboration. The maker in question requests, in step S25, the platform provider to register the makers concerned as an interfaced maker group. In step S24, the platform provider registers the makers as an interfaced maker group. This completes the maker registering step.

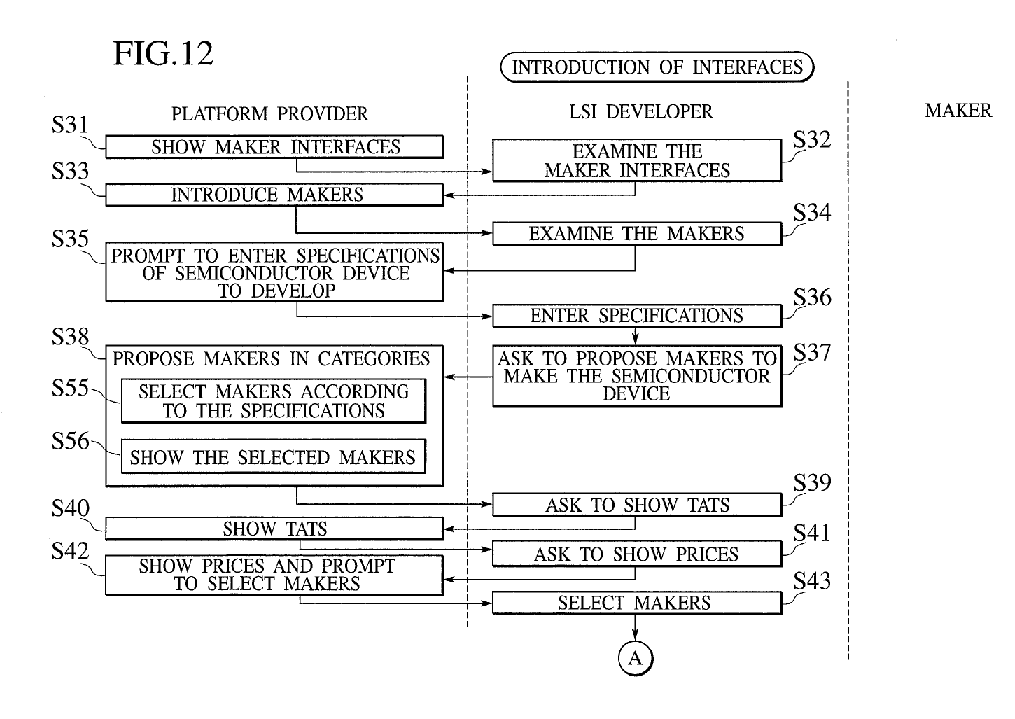

Next, the step of introducing maker groups according to the present invention carried out by the platform provider for a semiconductor device developer will be explained with reference to FIG. 12.

In step S31, the platform provider shows maker interfaces. In step S33, the platform provider introduces registered makers to the developer. Through steps S31 and S33, the developer gets the names of makers to which the developer can ask to manufacture a semiconductor device. In step S34, the developer sends its intention to go farther. At this time, the specification assisting unit 37 of FIG. 4 terminates the specification assisting procedure 47 of FIG. 5.

In step S35 of FIG. 12, the platform provider prompts the developer to enter specifications of a semiconductor device developed by the developer. At this moment, the maker retrieving unit 38 of FIG. 4 starts the maker retrieving procedure 48 of FIG. 5.

In step S36, the developer enters specifications, and in step S37, the developer requests the platform provider to propose makers in categories. In step S38, the platform provider proposes maker groups in categories. Step S38 includes step S55 in which the platform provider retrieves, from the interface file storage 26, maker groups that may satisfy the specifications provided by the developer, and step S56 in which the platform provider informs the developer of the retrieved maker groups. At this time, the maker retrieving unit 38 of FIG. 4 terminates the maker retrieving procedure 48 of FIG. 5.

In step S39, the developer requests the platform provider to display turnaround times (TATs) related to the proposed makers. In response to the request, the platform provider shows, in step S40, TATs related to the makers. At this time, the maker selecting unit 39 of FIG. 4 starts the maker selecting procedure 49 of FIG. 5.

In step S41, the developer requests the platform provider to show prices to be charged by the makers. In step S42, the platform provider shows prices related to the makers and prompts the developer to select one of the proposed maker groups. In step S43, the developer selects one of the maker groups. At this time, the maker selecting unit 39 of FIG. 4 terminates the maker selecting procedure 49 of FIG. 5.

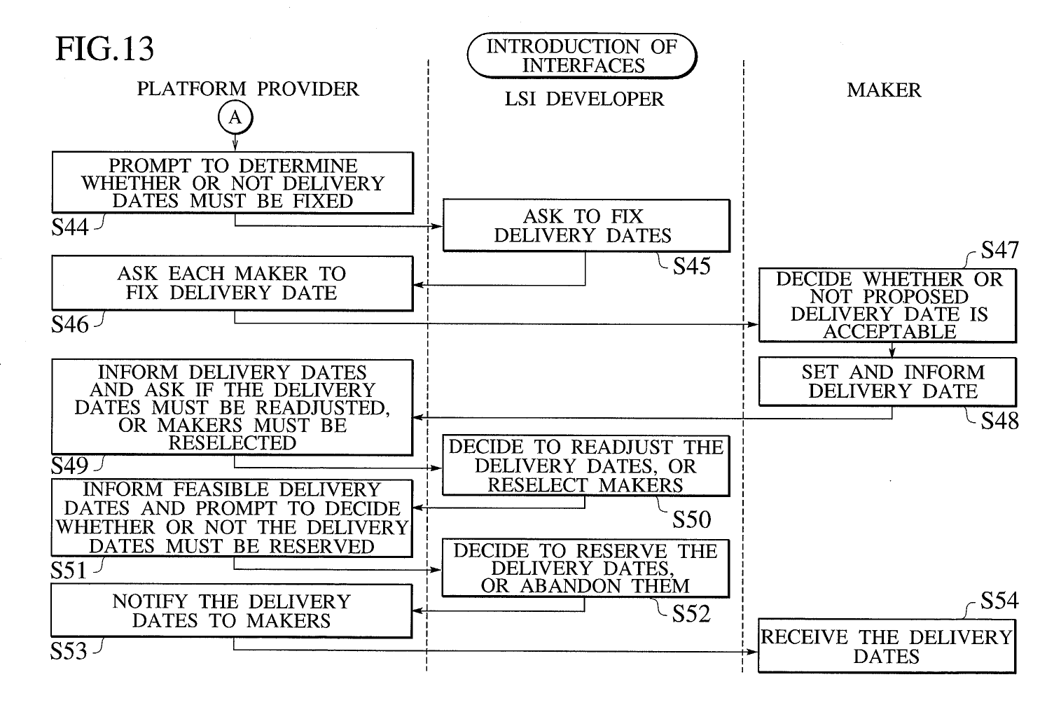

Referring to FIG. 13, the platform provider receives the selected maker group from the developer and prompts, in step S44, the developer to determine whether or not delivery dates must be fixed. At this time, the scheduling unit 40 of FIG. 4 starts the scheduling procedure 50 of FIG. 5. Each maker in the selected maker group will be provided with a delivery date on which the maker must hand over its product to the next maker, to complete a given semiconductor device in the maker group in collaboration.

In step S45, the developer determines that delivery dates must be fixed. In response to this, the platform provider informs, in step S46, each maker in the selected maker group of a delivery date and asks the maker whether the maker is able to keep the delivery date or wants to amend the delivery date.

Upon receiving the delivery date, the maker determines, in step S47, whether or not the delivery date is acceptable. In step S48, the maker sets a desirable delivery date, if necessary. According to data from each maker, the platform provider informs, in step S49, the developer of makers who want to change their delivery dates and asks the developer to determine whether the delivery dates must be adjusted or another maker group must be selected.

In step S50, the developer determines whether the delivery dates must be adjusted or a new maker group must be chosen. In step S51, the platform provider asks the developer to determine whether delivery dates feasible by the makers must be reserved or abandoned.

In step S52, the developer determines whether or not the delivery dates must be reserved. If they must be reserved, the platform provider informs, in step S53, each maker of the delivery date to be reserved. At this time, the scheduling unit 40 of FIG. 4 terminates the scheduling procedure 50 of FIG. 5. This completes the maker introducing step.

In this way, the platform provider acts as a mediator to register maker groups and introduce the maker groups to developers so that each developer may select one of the maker groups to produce a semiconductor device developed by the developer.

For the developers, the present invention enables them to set up optimum designing and developing environments to find out the best solution, and therefore, the developers can develop highly marketable semiconductor devices at low risk and low cost in a short time. With the present invention, the developers can select makers having specialized techniques to develop semiconductor devices. It is possible for the developers to determine makers after fixing the specifications of a semiconductor device, so that the developers may concentrate on developing semiconductor devices. At the same time, the present invention promotes makers to disclose their methods, costs, schedules, standard design techniques, etc., to expand choices for the developers. Also, the present invention promotes the disclosure of design tools from electronic design automation (EDA) tool makers because they are eager to establish a common LSI developing platform with their own tools. This further expands choices for the developers. The present invention also promotes the disclosure of libraries from silicon foundries and assemblers. This additionally expands choices for the developers.

According to the present invention, a platform providers may form environments in which specialized makers provide their own skills to developers.

With the present invention, specialized makers may improve their specialties and provide them to developers. This helps the makers improve their additional values, increase opportunities to obtain additional earnings, and reduce investment in new equipment.

The present invention enables semiconductor device developers to request specialized makers to manufacture semiconductor devices developed by the developers.

The present invention improves its efficiency by classifying makers into categories including logic designing, mask making, silicon foundry, assembling, and testing and by making maker groups based on the categories.

Next, the step of requesting the manufacturing of a semiconductor device and the step of obtaining a proposal for the request according to the present invention will be explained. These steps are carried out by a semiconductor device developer with respect to a platform provider through the computer network 2 when the developer wants to find makers capable of manufacturing a semiconductor device developed by the developer.

In step S32 of FIG. 12, the developer examines maker interfaces provided by the platform provider in step S31.

In step S34, the developer examines makers introduced by the platform provider in step S33.

In step S36, the developer enters the specifications of a semiconductor device in response to a request made by the platform provider in step S35.

In step S37, the developer asks the platform provider to propose maker groups that may satisfy the specifications entered in step S36.

In step S39, the developer examines maker groups proposed by the platform provider in step S38 and asks the platform provider to show turnaround times (TATs) related to the proposed maker groups.

In step S41, the developer asks the platform provider to show prices of the proposed maker groups.

In step S43, the developer selects one of the maker groups in response to a prompt made by the platform provider in step S42.

In step S45 of FIG. 13, the developer asks the platform provider to fix a delivery date for each maker in the selected maker group in response to a prompt from the platform provider made in step S44.

In step S50, the developer determines whether delivery dates must be adjusted or another maker group must be reselected in response to a prompt from the platform provider made in step S49.

In step S52, the developer determines whether rescheduled delivery dates must be reserved or abandoned in response to a prompt from the platform provider made in step S51.

The above steps from the standpoint of a developer are fundamentally the same as those from the standpoint of a platform provider mentioned first.

In this way, the present invention enables a semiconductor device developer to request categorized makers to fabricate a semiconductor device developed by the developer.

Next, the step of receiving a semiconductor device manufacturing order according to the present invention will be explained. This step is carried out by a semiconductor device maker through the computer network 2 and includes forming a maker group with other makers in other categories, registering the maker group, and introducing the maker group to a developer so that the developer may choose and ask the maker group to manufacture a semiconductor device developed by the developer.

Registering a maker group will be explained with reference to FIG. 11. In step S12, a maker requests registration through the network 2 in response to an invitation from a platform provider made in step S11.

In step S14, the maker enters a category to which the maker belongs in response to a prompt from the platform provider made in step S13.

In step S16, the maker enters another maker in another category with which the maker wants to be interfaced in response to a prompt made by the platform provider in step S15. At this time, the maker in question must select one maker in one category.

In step S18, the maker enters features and products of the maker in response to a prompt made by the platform provider in step S17.

In step S20, the maker determines whether interfacing cost is at its own expense or shared with a developer in response to a prompt made by the platform provider in step S19.

In step S22, the maker produces a sample semiconductor device to check interfacing with other makers with which the maker in question wants to be interfaced, in response to a request made by the platform provider in step S21.

In step S25, the maker asks the platform provider to register the interfaced makers including the maker in question that have produced the sample semiconductor device as an interfaced maker group.

Selecting a maker group will be explained.

In step S47 of FIG. 13, the maker determines whether or not a delivery date set for a semiconductor device developed by a developer is feasible, in response to an inquiry made by the platform provider in step S46.

If the specified delivery data is unacceptable, the maker sets a desired delivery date.

The above steps from the standpoint of a maker are fundamentally the same as those from the standpoint of a platform provider mentioned first.

In this way, the present invention enables a semiconductor device developer to request categorized makers to fabricate a semiconductor device developed by the developer.

Detailed steps taking place among platform provider, developer, and makers

The details of the steps of the present invention carried out by a platform provider, a semiconductor device developer, and makers will be explained. The details of the maker registration step carried out between a platform provider and a maker will be explained first, and then, the details of the maker introduction step carried out between the platform provider and a developer will be explained.

Maker registration

FIG. 11 shows a flow of registering a maker to a platform provider. In FIG. 11, steps carried out by the platform provider are on the left side, and those carried out by the maker are on the right side.

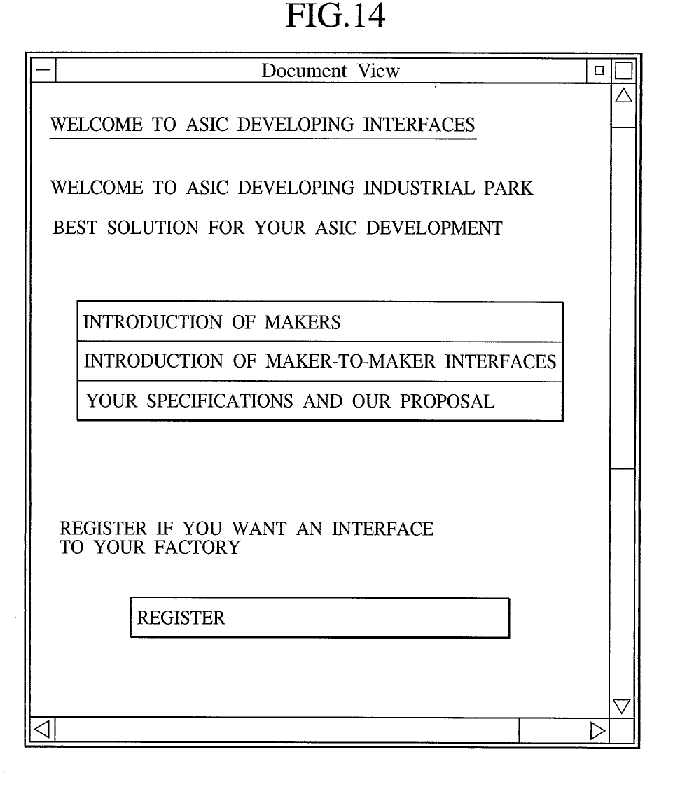

In step S11, the platform provider manipulates the server 1 of FIG. 2 to invite the maker to register. The maker manipulates the computer 3. The invitation from the platform provider is sent from the server 1 to the computer 3 through the network 2 and is displayed on the computer 3. In response, the maker manipulates the computer 3 to request registration. More precisely, the server 1 of the platform provider activates the controller 21 of FIG. 3. The controller 21 reads the main program 29 of FIG. 5 from the storage 24. According to the main program 29, the maker registering unit 31 in the controller 21 starts the maker registering procedure 41. Thereafter, the maker inviting unit 32 in the controller 21 starts the maker inviting procedure 42. The maker inviting unit 32 instructs the output controller 23 to display a document view of FIG. 14 on the display 56 of the computer 3. The output controller 23 converts the instruction into a signal transmittable through the network 2 and sends the signal to the computer 3. The input controller 52 of the computer 3 receives the signal, converts the signal into an instruction operable on the controller 51, and sends the instruction to the controller 51. In response to the instruction, the controller 51 displays the document view of FIG. 14 on the display 56. The input controllers 22 of FIG. 3, 52 of FIG. 6, and 62 of FIG. 7 achieve the same function. The output controllers 23 of FIG. 3, 53 of FIG. 6, and 63 of FIG. 7 achieve the same function. These controllers and functions realize communication among the server 1 and computers 3 through 16. In the following explanation, instructions and data are transferred among the controllers 21, 51, and 61 through the input and output controllers 22, 23, 52, 53, 62, and 63 even if not particularly mentioned.

The document view of FIG. 14 includes a message of “Register if you want an interface to your factory.” Seeing this message, the maker wants to register itself.

In step S12 of FIG. 11, the maker requests the platform provider to register. More precisely, the maker pushes a button “Register” of FIG. 14 with the input unit 57 which may be a mouse or a keyboard. The signal from the input unit 57 is transferred to the controller 51 and to the controller 21, which informs the platform provider of the registration request of the maker. At this time, the maker inviting unit 32 terminates the maker inviting procedure 42.

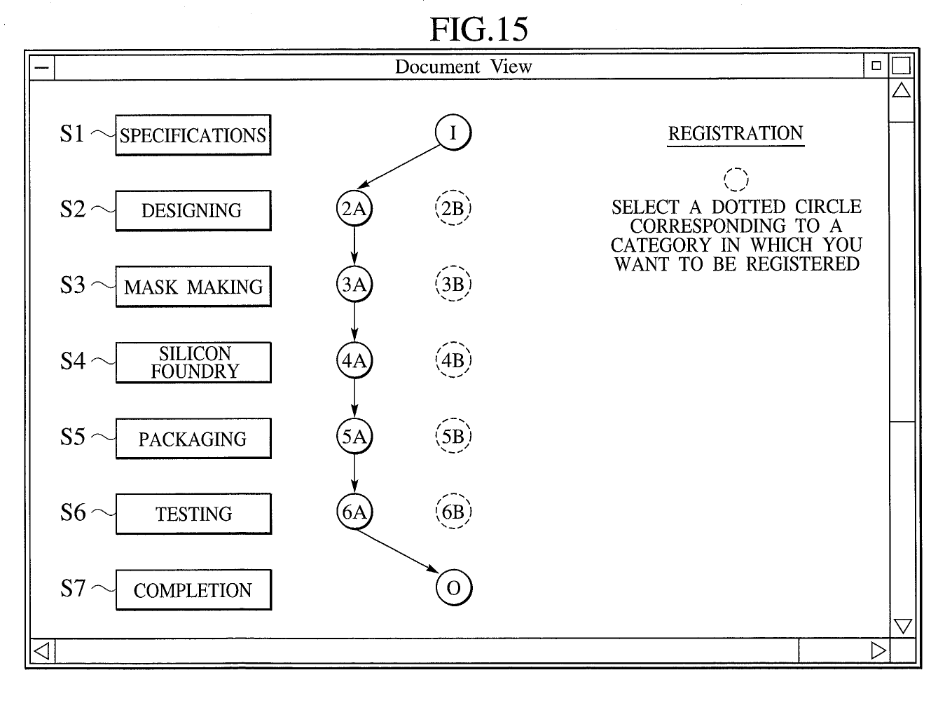

The maker organizing unit 33 starts the maker organizing procedure 43. In step S13 of FIG. 11, the platform provider prompts the maker to enter a category in which the maker wants to be registered. The controller 21 instructs the controller 51 to display a document view of FIG. 15 on the display 56. This document view includes a message of “Select a dotted circle corresponding to a category in which you want to be registered.” This message prompts the maker to enter a category. The document view of FIG. 15 shows that a logic designer 2A, a mask maker 3A, a silicon foundry 4A, a package assembler 5A, and a tester 6A are already registered. Here, the labels 2A to 6A, etc., are maker identification labels and an arrow mark between makers indicates that the makers are interfaced with each other. The interfaced maker group 2A-6A indicates that a developer may hand over semiconductor device specifications to the maker 2A and receive a finished semiconductor device from the maker 6A.

In step S14 of FIG. 11, the maker determines a category in which the maker wants to be registered. The maker clicks a circle around “4B” of FIG. 15 with the input unit 57, to send a signal representing “4B.” As a result, the platform provider acknowledges the selected category 4B through the controllers 51 and 21.

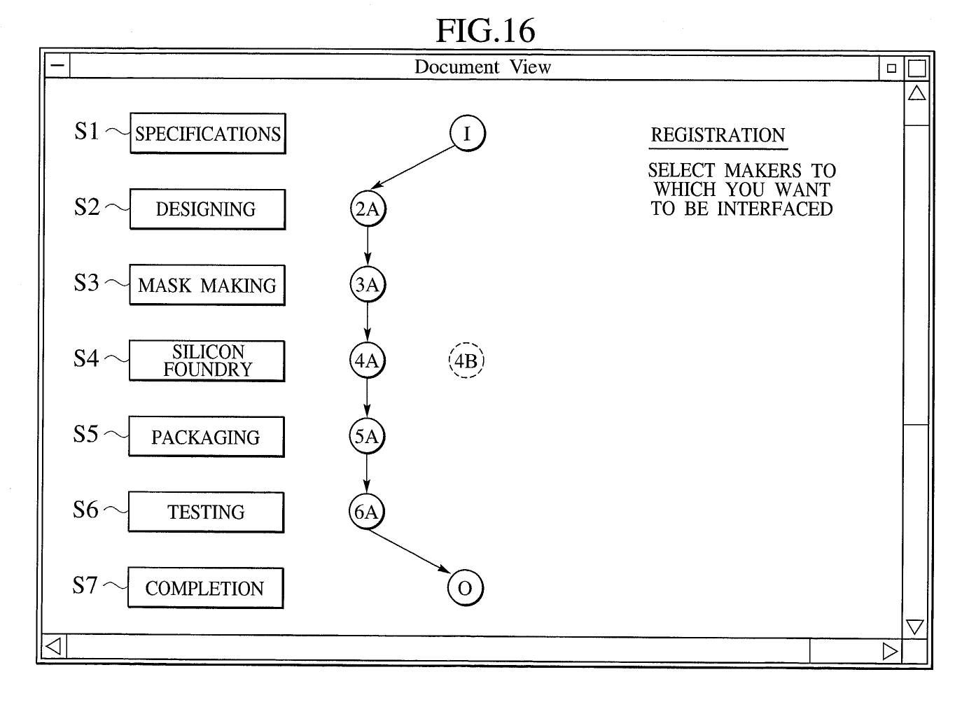

In step S15 of FIG. 11, the platform provider prompts the maker to enter another maker in another category with which the maker wants to be interfaced. At this time, the maker is requested to enter one maker for one category. The controller 21 of the server 1 instructs the controller 51 of the computer 3 to display a document view of FIG. 16 on the display 56. The document view of FIG. 16 shows the maker label 4B representing the maker in question. The maker labels 2B, 3B, 5B, and 6B of FIG. 15 are deleted in FIG. 16. The document view of FIG. 16 has a message of “Select makers to which you want to be interfaced” to prompt the maker to select makers in other categories.

In step S16 of FIG. 11, the maker selects makers in other categories with which the maker wants to be interfaced. In this example, the maker selects makers 3A and 5A of FIG. 16 by clicking circles around the labels 3A and 5A. Signals representing the makers 3A and 5A are sent from the input unit 57 to the controller 51 and to the controller 21. Consequently, the platform provider acknowledges that the maker has selected the makers 3A and 5A as makers to be interfaced.

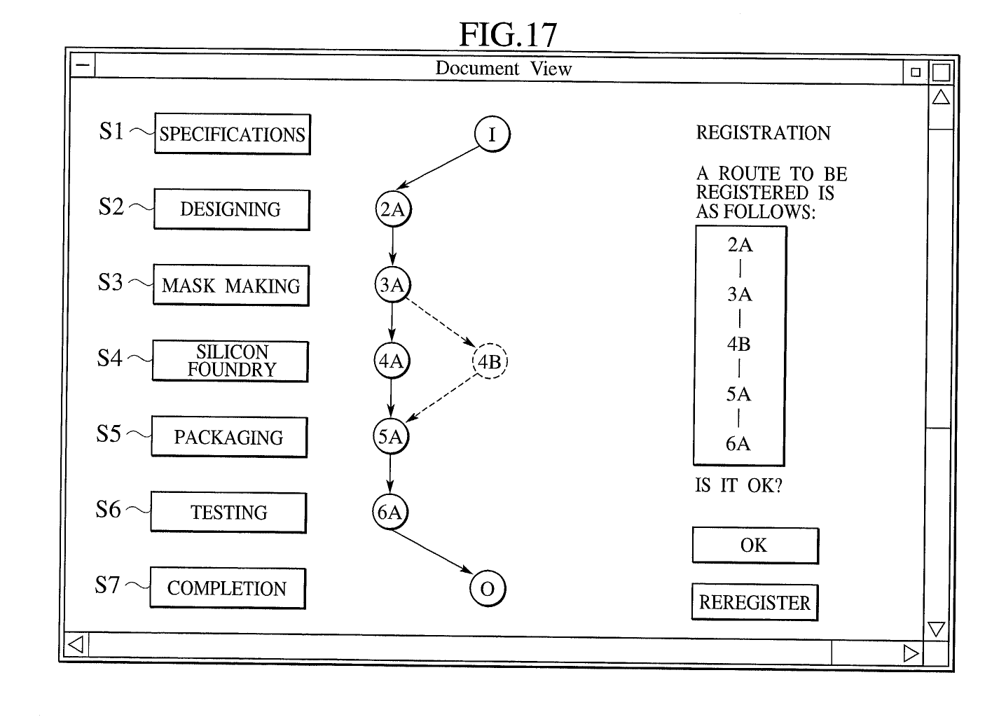

The platform provider prompts the maker to confirm the makers to be interfaced. The controller 21 instructs the controller 51 to display a document view of FIG. 17 on the display 56. The document view of FIG. 17 shows the maker 4B in question, an arrow mark from the maker 3A to the maker 4B, and an arrow mark from the maker 4B to the maker 5A. The document view also shows a message of “A route to be registered is as follows: 2A-3A-4B-5A-6A. Is it OK?” This message prompts the maker to confirm if the displayed maker interfacing is the desired one. If it is wrong, the maker pushes a button “Reregister.” If it is correct, the maker pushes a button “OK.” In this example, the maker pushes the button “OK” through the input unit 57, which sends an OK signal to the controller 51 and to the controller 21. As a result, the platform provider acknowledges that the maker interfacing now being displayed is the one the maker desires and organizes a maker group of the makers 2A, 3A, 4B, 5A, and 6A. There is an already organized maker group of the makers 2A, 3A, 4A, 5A, and 6A who are already interfaced with one another and are capable of manufacturing semiconductor devices in collaboration with one another. The newly organized maker group 2A-3A-4B-5A-6A is not yet interfaced, and therefore, it is not clear whether or not they can manufacture semiconductor devices in collaboration with one another.

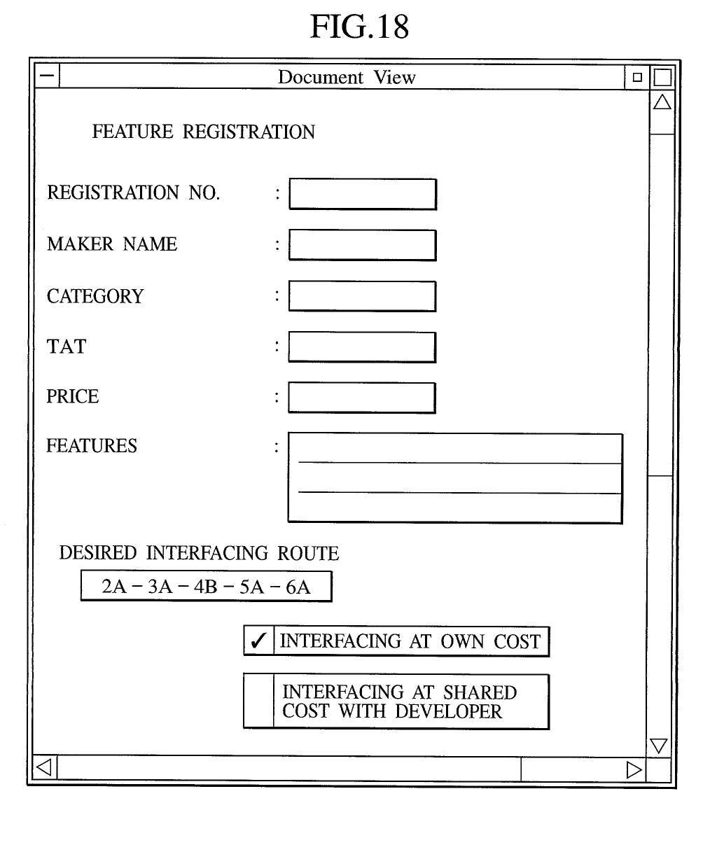

In step S17 of FIG. 11, the platform provider prompts the maker to enter products and technical features specific to the maker. The controller 21 instructs the controller 51 to display a document view of FIG. 18 on the display 56. This document view has blanks for a registration number, maker name, turnaround time (TAT), price, and features. The maker is prompted to fill the blanks.

In step S18 of FIG. 11, the maker uses the input unit 57 to enter the maker name, TAT, price, features, etc. The input data is stored in the storage 25 (FIG. 3) through the controllers 51 and 21 and in the storage 55 (FIG. 6) through the controller 51. At this time, the maker organizing unit 33 of FIG. 4 terminates the maker organizing procedure 43 of FIG. 5.

The interface confirming unit 34 starts the interface confirming procedure 44. In step S19 of FIG. 11, the platform provider prompts the maker to determine whether an interfacing cost is at the maker's own expense or is shared with a developer. The controller 21 instructs the controller 51 to display the document view of FIG. 18. This document view shows the interface route requested by the maker, a check box of “Interfacing at own cost,” and a check box of “Interfacing at shared cost with developer.” The maker sees the document view and makes its determination accordingly.

In step S20 of FIG. 11, the maker determines who bears the interfacing cost by checking one of the “Interfacing at own cost” and “Interfacing at shared cost with developer” with the input unit 57. In this example, the maker checks the “Interfacing at own cost.” The platform provider acknowledges, through the controllers 51 and 21, that the interfacing cost is borne by the maker.

By bearing the interfacing cost, the maker can form an interface without waiting for a developer who wants to share the interfacing cost, and therefore, can quickly introduce the maker's products into the market. By sharing the interfacing cost with a developer, the maker can form an interface while manufacturing a semiconductor device developed by the developer, and therefore, the interfacing cost borne by the maker and the manufacturing cost borne by the developer will be reduced. In addition, the developer may adopt latest techniques provided by makers, to develop a high-performance semiconductor device. The sharing of an interfacing cost, however, involves a risk of failing to establish a proper interface for a semiconductor device developed by the developer. In this case, the maker and developer are obliged to bear the risk.

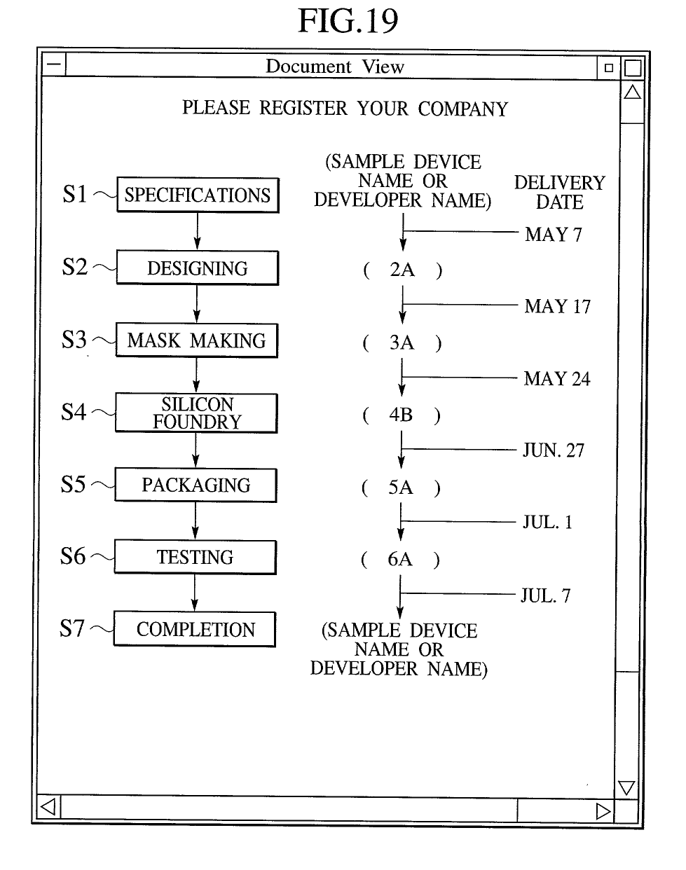

In step S21 of FIG. 11, the platform provider asks the makers 2A, 3A, 4B, 5A, and 6A in the newly organized maker group 2A-3A-4B-5A-6A to produce a sample semiconductor device to test the correctness of interfaces among the makers. This step is carried out without a developer if the maker 4B bears the interfacing cost, or after the emergence of a developer if the maker 4B wants to share the interfacing cost with a developer At this time, the makers 4B, 2A, 3A, 5A, and 6A control the computers 3, 11, 10, 9, and 8, respectively. The controller 21 of the server 1 of FIG. 3 instructs the controllers 51 of the computers 3 and 8 to 11 to display a document view of FIG. 19. This document view has a message of “Please register your company” and a schedule for manufacturing the sample semiconductor device. The schedule specifies delivery dates among the makers. The makers 2A, 3A, 4B, 5A, and 6A are asked to fabricate the sample semiconductor device according to the schedule.

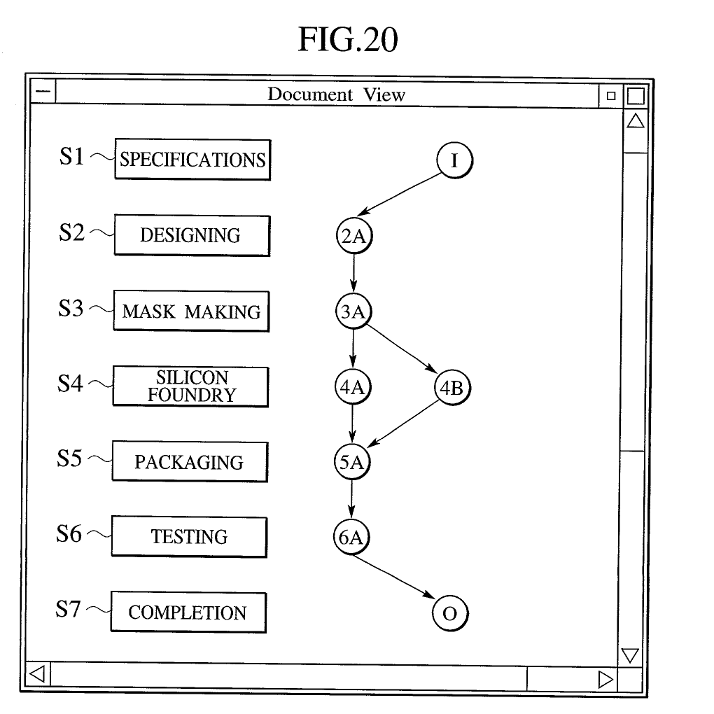

In steps S22 and S23 of FIG. 11, the maker group 2A-3A-4B-5A-6A fabricates the sample semiconductor device. The specifications of the sample semiconductor device are provided by the platform provider when the interfacing cost is borne by the maker 4B. When the interfacing cost is shared between the maker 4B and a developer, the specifications are provided by the developer. When the sample semiconductor device is completed, it is tested according to the specifications. If the test is successful, it is determined that the makers of the maker group are interfaced with one another. This interfaced state of the maker group is shown in a document view of FIG. 20. Then, the interface confirming unit 34 terminates the interface confirming procedure 44.

The maker recording unit 35 of FIG. 4 starts the maker recording procedure 45 of FIG. 5. Upon a successful test result, the maker 4B requests, in step S25, the platform provider to record the maker group 2A-3A-4B-5A-6A as an interfaced maker group. This request is transferred from the input unit 57 of the computer 3 to the controller 21 through the controller 51. The controller 21 prepares an interface file 72 (FIG. 9) for the maker group 2A-3A-4B-5A-6A and stores it in the storage 26 (FIG. 3). The interface file 72 of FIG. 9 has an area 77 for categories, which are related to maker names in an area 78, respectively. The maker names in the area 78 are related to turnaround times (TATs), prices, and numbers in areas 79, 80, and 81, respectively. The data pieces in the areas 79 to 81 are retrieved from maker files 71 of FIG. 8 according to the maker names. The maker recording unit 35 terminates the maker recording procedure 45, and the maker registering unit 31 terminates the maker registering procedure 41.

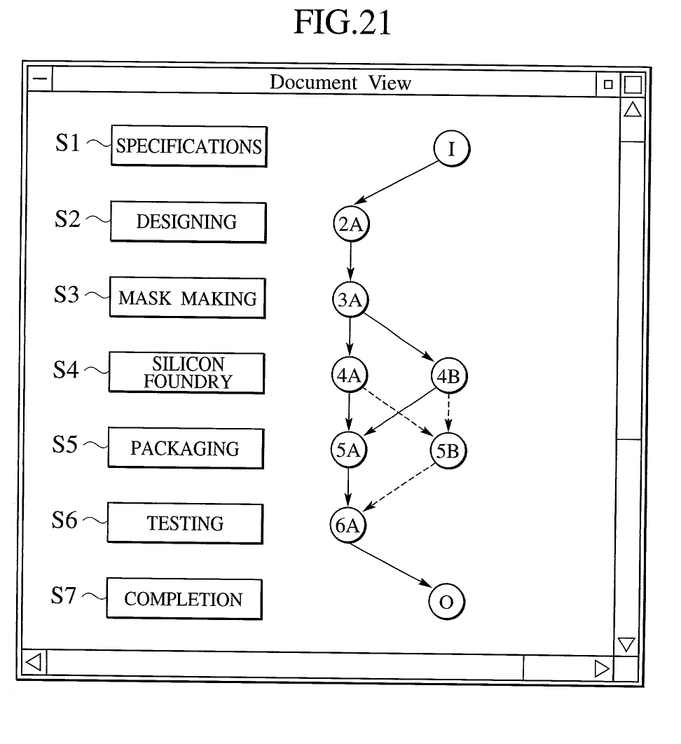

FIG. 21 shows registration of a new maker 5B. The maker 5B wants to be interfaced with the makers 4A, 4B, and 6A. To achieve this, a maker group 2A-3A-4A-5B-6A and a maker group 2A-3A-4B-5B-6A are requested to fabricate sample semiconductor devices, respectively. If the sample semiconductor devices successfully pass tests, the two maker groups are recognized and registered as interfaced maker groups.

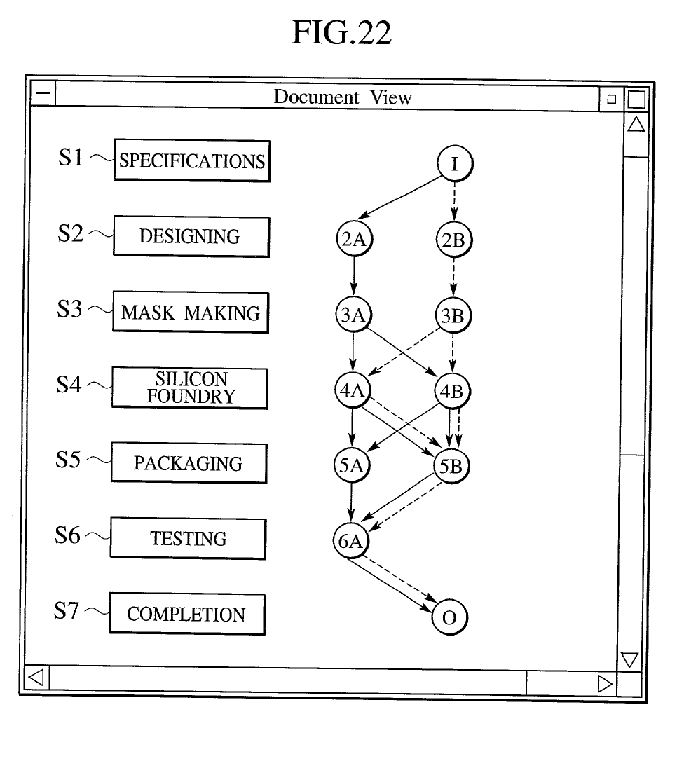

FIG. 22 shows registration of new makers 2B and 3B. The maker 2B wants to be interfaced with the maker 3B. The maker 3B wants to be interfaced with the makers 4A and 4B. To achieve this, a maker group 2B-3B-4A-5B-6A and a maker group 2B-3B-4B-5B-6A are requested to fabricate sample semiconductor devices, respectively. If the sample semiconductor devices successfully pass tests, the two maker groups are admitted as interfaced maker groups. These two maker groups do not include the maker 5A. Namely, if the makers 2B and 3B are selected, the maker 5A will be excluded. It is presumed that a new maker, who wants to be registered, wants to be interfaced with makers having improved technology. This means that any maker who wants interfacing requests from other makers must maintain latest technology. This enables the platform provider to provide developers with latest semiconductor device manufacturing technology.

Maker group introduction

Introducing maker groups from the platform provider to a developer will be explained.

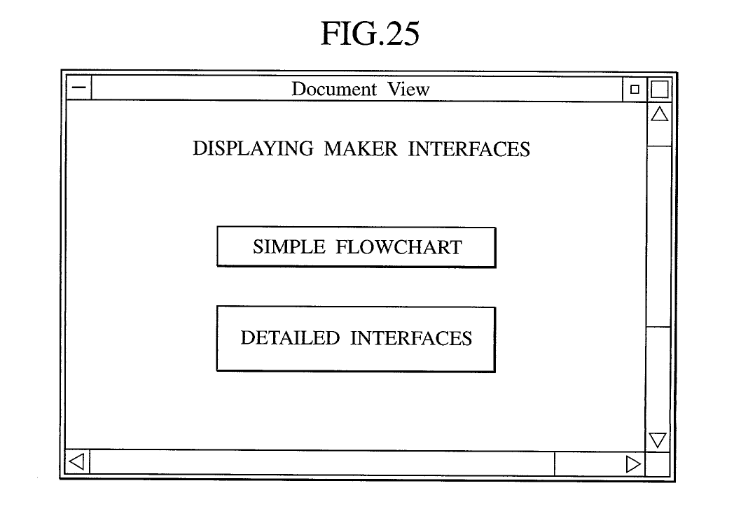

The maker introducing unit 36 of FIG. 4 starts the maker introducing procedure 46 of FIG. 5, and the specification assisting unit 37 starts the specification assisting procedure 47. In step S31 of FIG. 12, the platform provider shows maker interfaces to a semiconductor device developer. The developer manipulates, for example, the computer 16 of FIG. 2. The controller 21 of the server 1 manipulated by the platform provider instructs the controller 61 (FIG. 7) of the computer 16 to display the document view of FIG. 14. This document view includes a button with a message of “Introduction of maker-to-maker interfaces.” This message may attract attention of the developer. The developer pushes the button with the input unit 67. The signal from the input unit 67 is transferred to the controller 21 through the controller 61. The controller 21 and platform provider acknowledge the desire of the developer of seeing the maker interfaces. The controller 21 instructs the controller 61 to display a document view of FIG. 25 on the display 66. This document view has buttons of “Simple flowchart” and “Detailed interfaces” so that the developer may select one of the buttons.

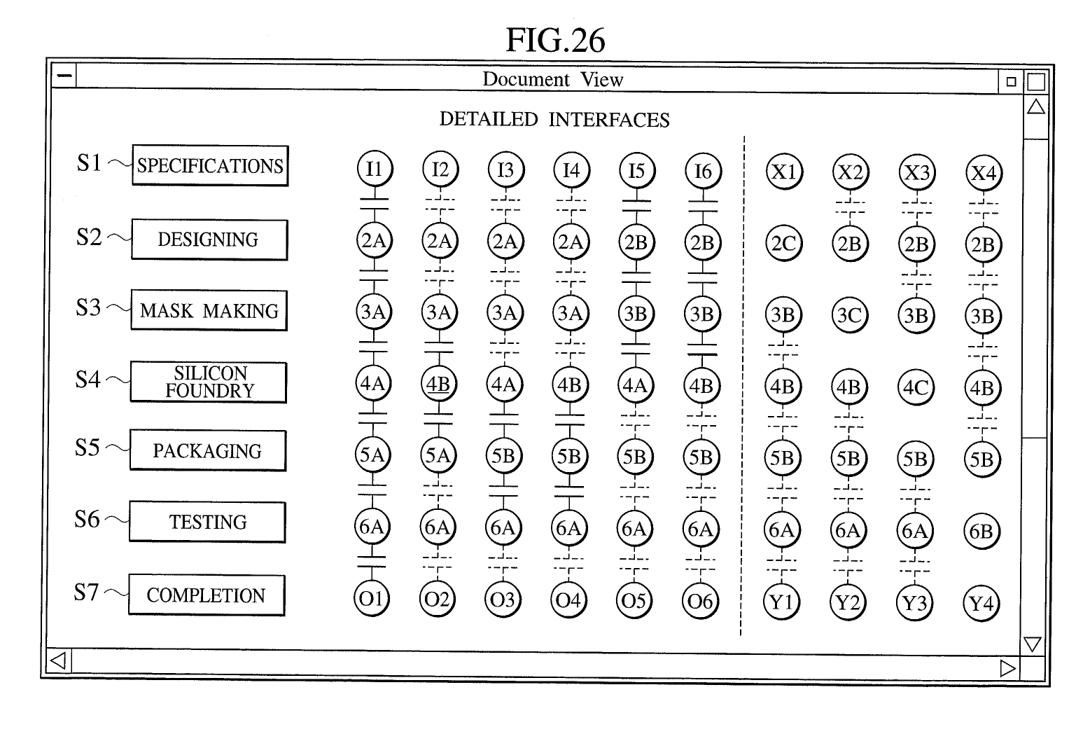

If the developer selects the button “Detailed interfaces,” the selection is transferred from the input unit 67 to the controllers 61 and 21. The controller 21 instructs the controller 61 to display a document view of FIG. 26 on the display 66 in step S31 of FIG. 12. The document view of FIG. 26 show makers 2A to 6A, 2B to 6B, and 2C to 4C in categories. Labels I1 to I6 and X1 to X4 represent specifications with anonymous developers. Labels O1 to O6 and Y1 to Y4 represent semiconductor devices with anonymous developers. The makers are listed in order of registration dates from left to right. The newer the registration date, the more rightwardly the related maker is positioned in FIG. 26. A T-shaped mark between vertically adjacent makers represents an interface between the makers. An interface depicted with a solid line is newer than an interface on the left thereof. An interface depicted with a doted line is temporally equal to an interface on the left thereof. The makers 2C, 3C, 4C, and 6B are not interfaced with vertically adjacent makers. This means that these makers want to establish interfaces at shared cost with developers. As mentioned above, the more rightwardly an interface is positioned, the newer the technology the interface involves. From the document view of FIG. 26, the developer grasps makers who are frequently adopted and interfaces that are frequently employed. Namely, in step S32, the developer grasps technical trends related to semiconductor device manufacturing from the document view of FIG. 26 and wants to know the details of attractive makers.

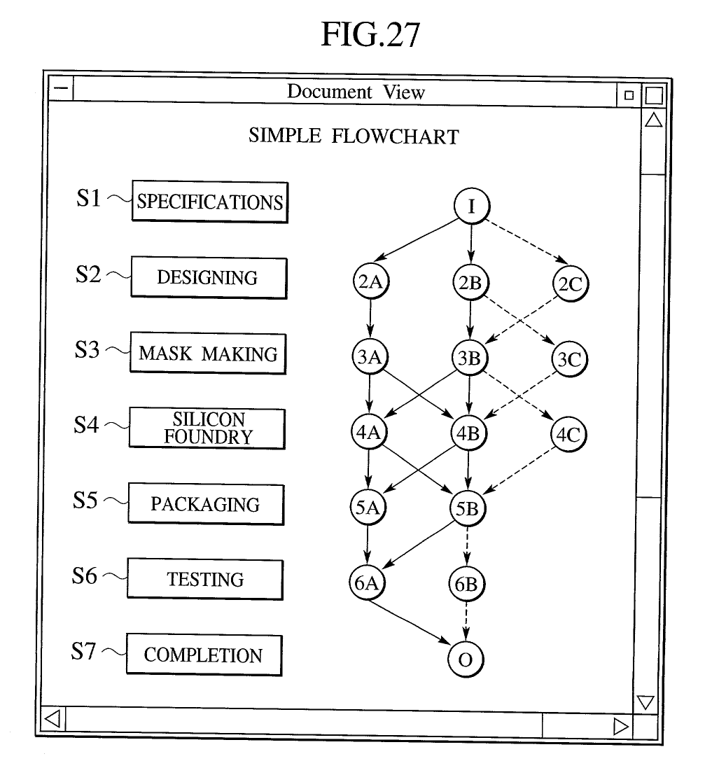

If the developer selects the button “Simple flowchart” of FIG. 25, the selected signal is transferred from the input unit 67 to the controllers 61 and 21. The controller 21 instructs the controller 61 to display a document view of FIG. 27 on the display 66 in step S31 of FIG. 12. The document view of FIG. 27 shows the makers 2A to 6A, 2B to 6B, and 2C to 4C in categories. A solid-line arrow between makers indicates an existing interface, and a dotted-line arrow between makers indicates an interface to be established at shared cost with a developer. The more rightwardly a maker is positioned in FIG. 27, the newer technology the maker may have. A maker to which arrow marks concentrate may have standard technology of the category to which the maker belongs. By studying these characteristics of FIG. 27, the developer may desire to study the details of attractive makers.

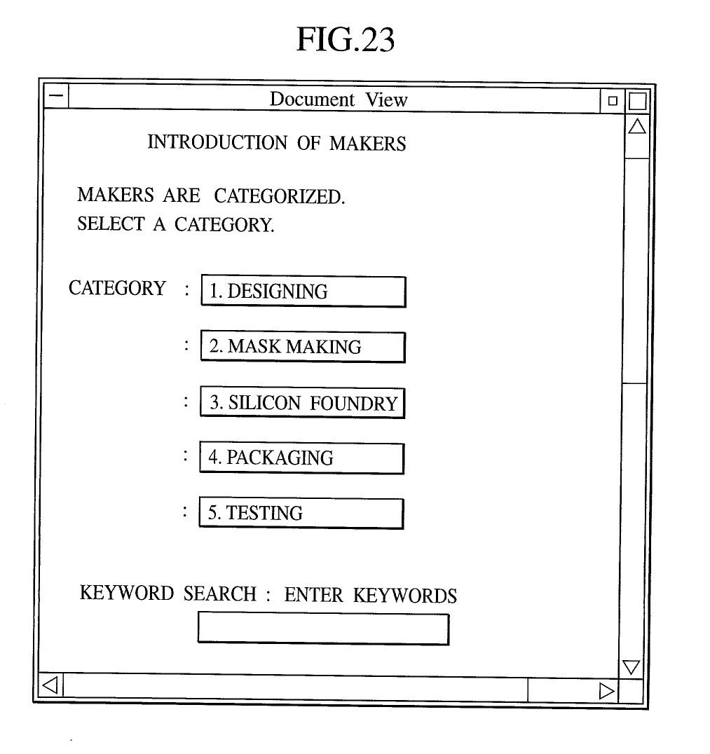

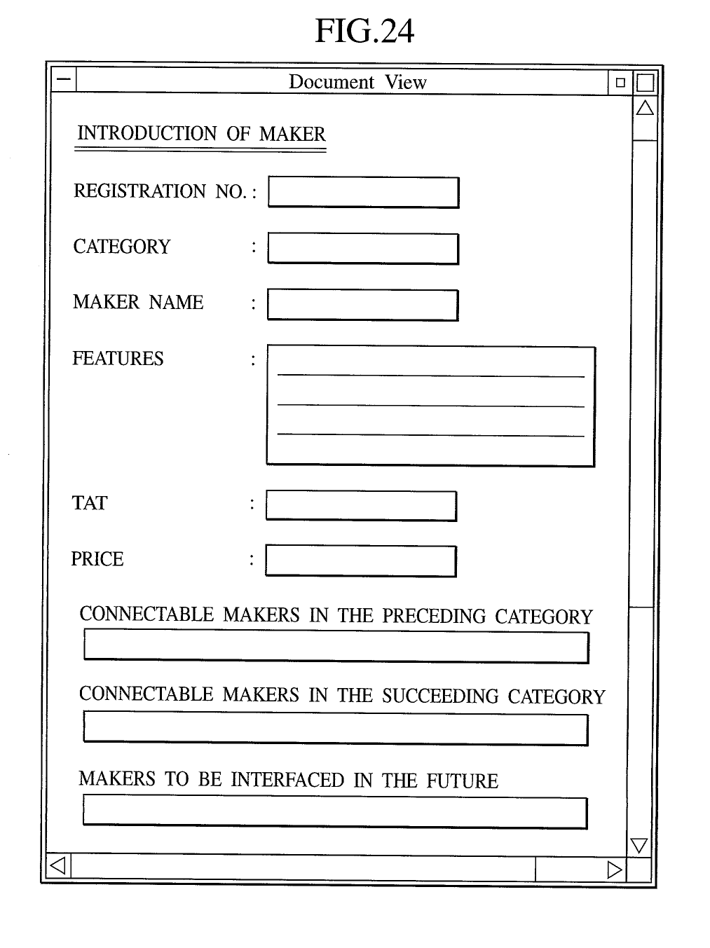

In step S33 of FIG. 12, the platform provider introduces makers to the developer. The controller 21 instructs the controller 61 to display the document view of FIG. 14. This document view includes a button with a message of “Introduction of makers.” Seeing this message, the developer may want to examine the technical details, etc., of each maker and clicks the button. The clicked signal is transferred from the input unit 67 to the controller 21 through the controller 61. The controller 21 and platform provider acknowledge the developer's intention. The controller 21 instructs the controller 61 to display a document view of FIG. 23 for retrieving makers, or a document view of FIG. 24 introducing a maker. The document view of FIG. 23 shows category names and a message of “Keyword search: Enter keywords” to prompt the developer to select one of the categories to examine. The document view of FIG. 24 is available for each maker in response to a developer's request. The document view of FIG. 24 includes, for a given maker, a name, technical features, TAT, price, interfaced makers, and makers with which the maker in question wants to be interfaced in the future. In step S34 of FIG. 12, the developer examines introduced makers and determines whether or not they have required abilities. At this time, the specification assisting unit 37 terminates the specification assisting procedure 47.

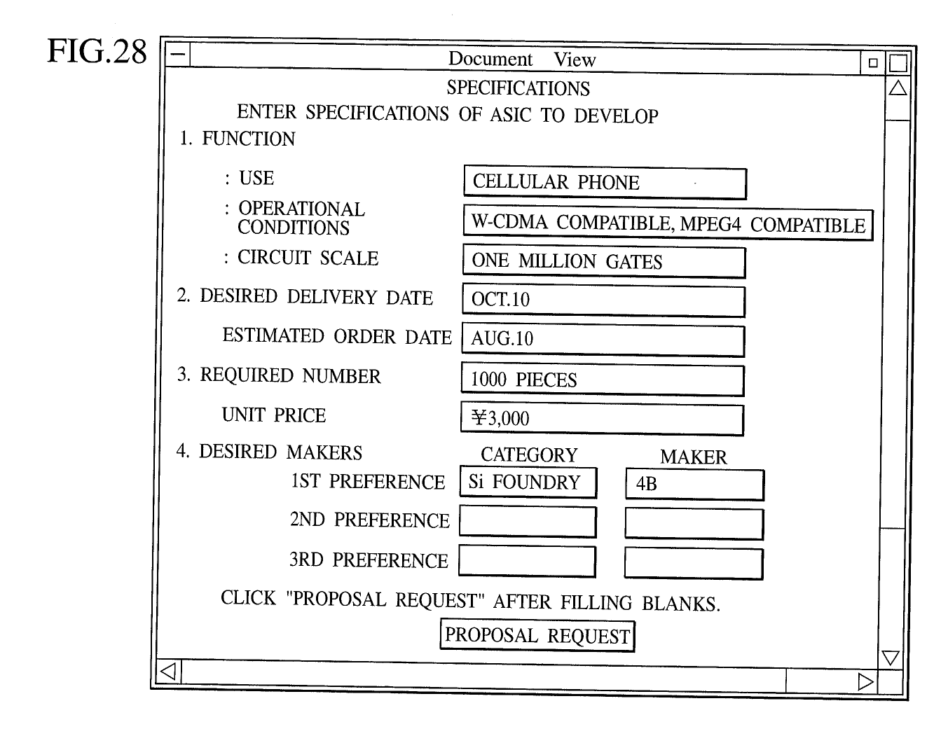

The maker retrieving unit 38 of FIG. 4 starts the maker retrieving procedure 48 of FIG. 5. In step S35 of FIG. 12, the platform provider prompts the developer to enter the specifications of a semiconductor device developed by the developer. The controller 21 instructs the controller 61 to display the document view of FIG. 14 on the display 66. This document view includes a button with a message of “Your specifications and our proposal.” Seeing this message, the developer wants to receive a proposal for interfaced maker groups who may satisfy the specifications of the developed semiconductor device. Accordingly, the developer clicks that button. The clicked signal is transferred from the input unit 67 to the controller 21 through the controller 61. The controller 21 and platform provider acknowledge the intention of the developer for a proposal. The controller 21 instructs the controller 61 to display a document view of FIG. 28 on the display 66. This document view includes a message of “Enter specifications of ASIC to develop” and blanks for functions including use, operational conditions, and circuit scale, delivery date, estimated order date, required number, desired unit price, and desired makers. The developer is prompted to fill the blanks.

In step S36 of FIG. 12, the developer enters the specifications of the semiconductor device developed by the developer as shown in FIG. 28.

The controller 21 prompts the developer to ask for a proposal. The controller 21 displays a message of “Click ‘Proposal Request’ after filling blanks” as shown in FIG. 28. In step S37, the developer pushes a button “Proposal Request” of FIG. 28 to request the platform provider to propose maker groups who are able to manufacture the semiconductor device. The request signal is transferred from the input unit 67 to the controller 21 through the controller 61.

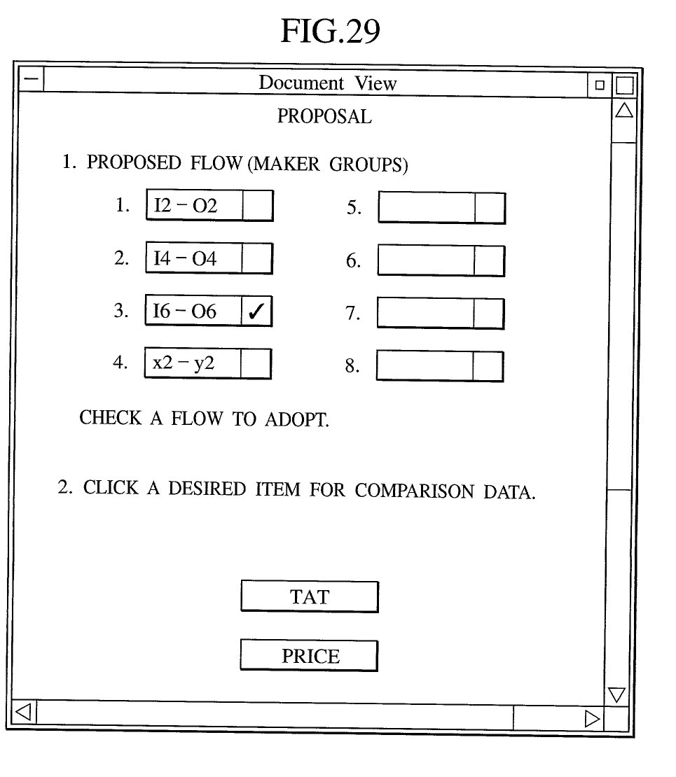

In step S38 of FIG. 12, the platform provider proposes maker groups in categories to manufacture the semiconductor device developed by the developer. The controller 21 instructs the controller 61 to display a document view of FIG. 29 on the display 66. This document view has a message of “Proposed flow (maker groups)” and columns numbered from 1 to 8. The columns contain maker groups in categories. These maker groups are retrieved and arranged by the platform provider in steps S55 and S56. In FIG. 29, the maker group I2-O2 corresponds to the maker group in the second column from the left in FIG. 26 and is represented with the specification label I2 and completion label O2. Similarly, the maker group I4-O4 corresponds to the maker group in the fourth column from the left, the maker group I6-O6 to the sixth column from the left, and x2-y2 to the eighth column from the left in FIG. 26. These four maker groups retrieved by the platform provider in step S55 include each the silicon foundry 4B because the developer has desired the silicon foundry 4B in step S36 as shown in FIG. 28. At this time, the maker retrieving unit 38 of FIG. 4 terminates the maker retrieving procedure 48.

The maker selecting unit 39 of FIG. 4 starts the maker selecting procedure 49 of FIG. 5. The platform provider prompts the developer to select one of the four proposed maker groups. At the same time, the platform provider asks the developer if the developer needs data related to the turnaround times (TATs) and prices of the maker groups for the convenience of the developer of selecting a maker group. In step S39 of FIG. 12, the developer asks the platform provider to display TATs by clicking a button “TAT” of FIG. 29.

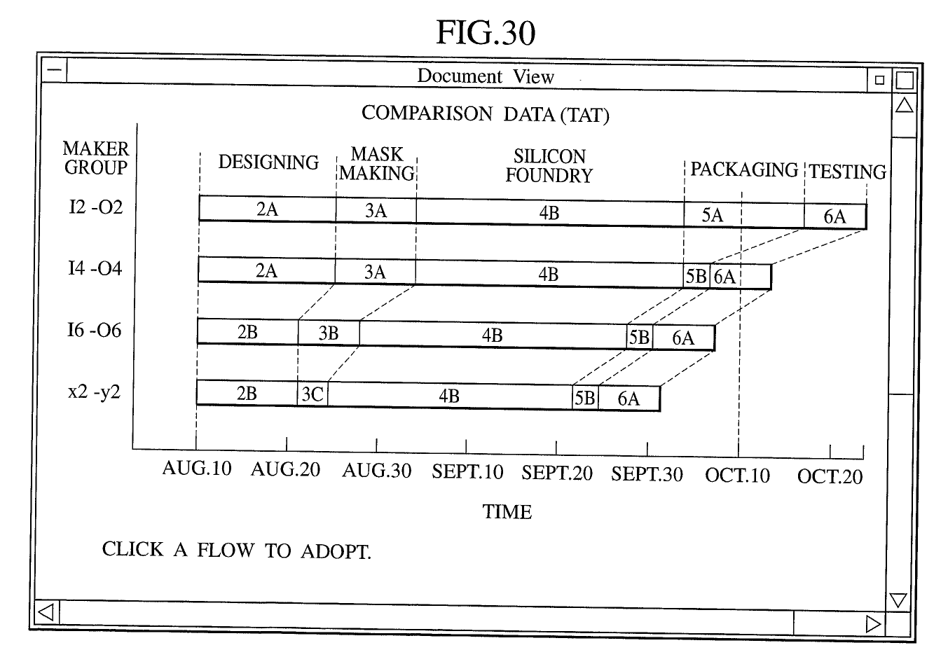

In step S40, the platform provider displays the TATs. The controller 21 instructs the controller 61 to display a document view of FIG. 30 on the display 66. This document view shows TATs for the maker groups, respectively. A schedule of each maker group is represented with a bar graph and is related to the delivery date and order date set by the developer. From the data, the developer understands that the maker group I6-O6 or x2-y2 satisfies the delivery date.

For the convenience of the developer of selecting a maker group, the platform provider asks the developer if the developer wants to see price comparison data. In step S41 of FIG. 12, the developer asks the platform provider to display prices of the maker groups, respectively, by clicking a button “Price” of FIG. 29.

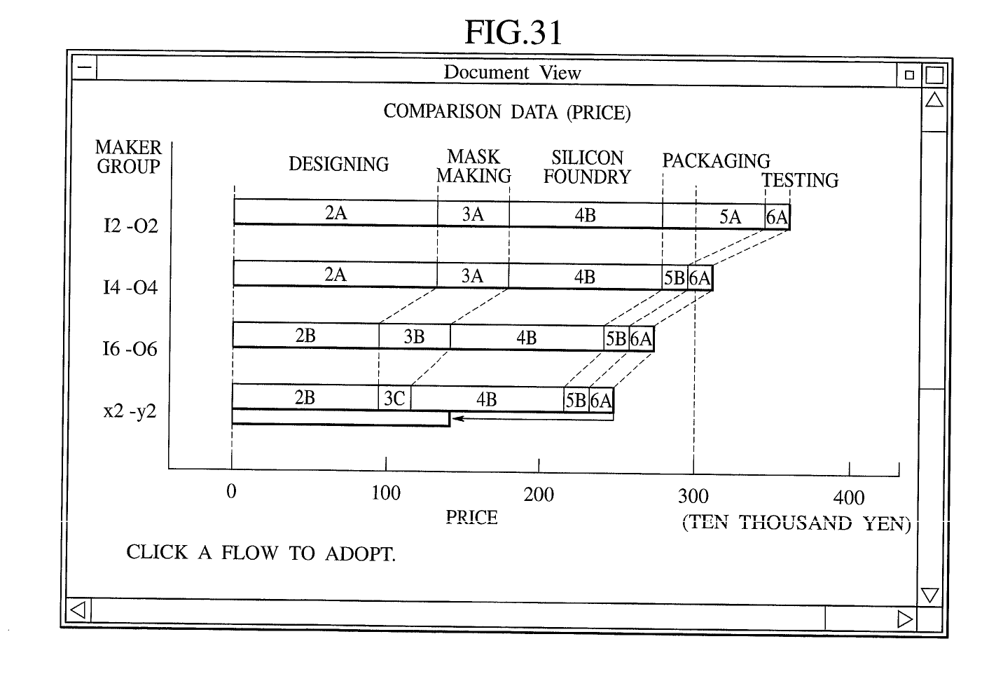

The platform provider shows the prices. The controller 21 instructs the controller 61 to display a document view of FIG. 31 on the display 66. The total price of each maker group is proportional to the length of a corresponding bar graph. According to the number and unit price entered by the developer in FIG. 28, a budget desired by the developer is three million yen. From the data of FIG. 31, the developer understands that the maker groups I6-O6 and x2-y2 satisfy the budget. The maker group x2-y2 involves incomplete interfaces and must wait for a developer who shares an interfacing cost. Accordingly, the price of the maker group x2-y2 is discounted by about half.

In step S42 of FIG. 12, the controller 21 of the platform provider prompts the developer to select one of the maker groups. The controller 21 instructs the controller 61 to display a message of “Check a flow to adopt” in the document view of FIG. 29.

In step S43 of FIG. 12, the developer selects, for example, the maker group I6-O6. The platform provider acknowledges, through the controller 21, that the maker group selected by the developer is I6-O6. At this time, the maker selecting unit 39 terminates the maker selecting procedure 49.

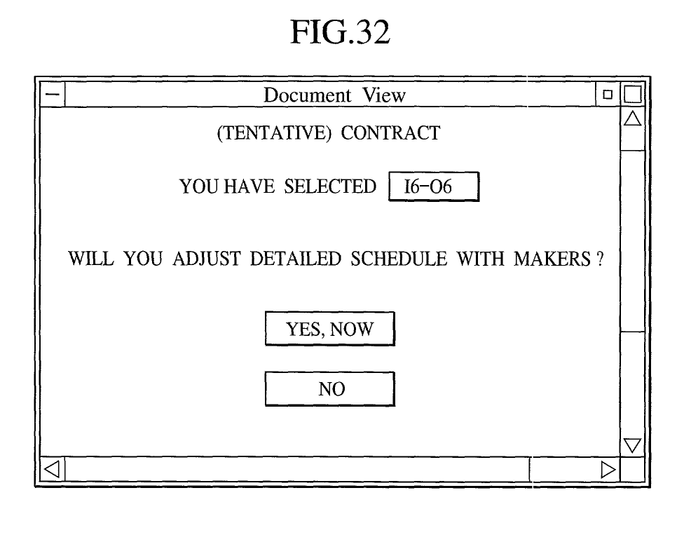

The scheduling unit 40 of FIG. 4 starts the scheduling procedure 50 of FIG. 5. In step S44 of FIG. 13, the platform provider prompts the developer to determine whether or not the delivery dates of the makers must be fixed. The controller 21 instructs the controller 61 to display a document view of FIG. 32 on the display 66. This document view has a message of “Will you adjust detailed schedule with makers?” and buttons of “Yes, now” and “No.” The reason why delivery dates must be fixed separately from the TATs is because the TATs do not always represent the actual operating conditions of the makers, and therefore, available lines of the makers must be reserved for manufacturing the semiconductor device developed by the developer.

In step S45, the developer requests the platform provider to fix delivery dates by clicking the button “Yes, now.” This request is transferred from the input unit 67 to the controller 21 through the controller 61.

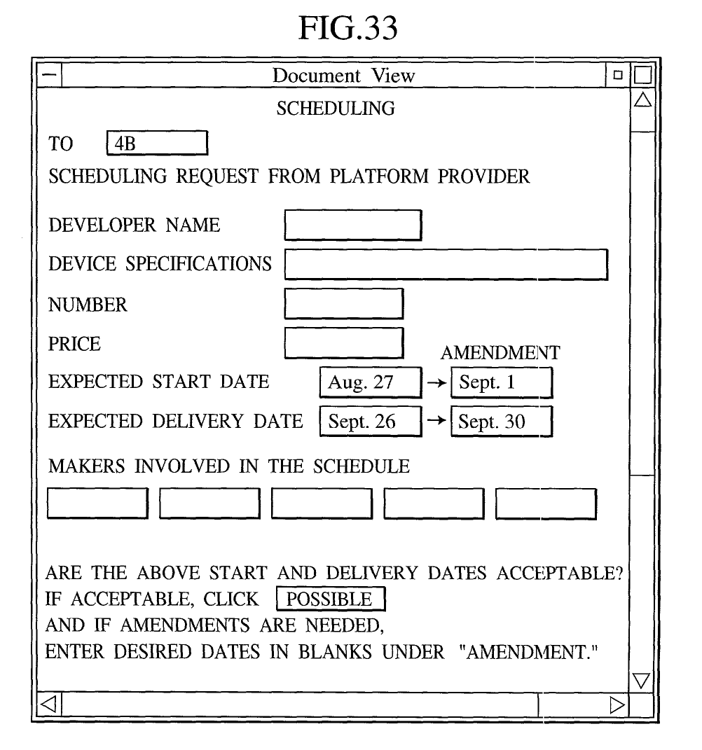

In step S46, the platform provider informs, through the controller 21 of the server 1 shown in FIG. 2, the makers 2B, 3B, 4B, 5B, and 6A in the maker group I6-O6 of respective delivery dates and asks them to determine whether the delivery dates are feasible or must be amended. The makers 2B, 3B, 4B, 5B, and 6A manipulate the computers 4 to 8 of FIG. 2, respectively. The controller 21 of the platform provider instructs the controllers 51 of the computers 4 to 8 to display a document view of FIG. 33 on the displays 56. As an example, the document view of FIG. 33 is for the maker 4B at the computer 6. This document view has a message of “Scheduling request from platform provider,” a developer name, device specifications, number, price, expected start date on which the maker 4B receives an intermediate product from the preceding maker, expected delivery date on which the maker 4B delivers its product to the succeeding maker, makers involved in the schedule, and a message of “Are the above start and delivery dates acceptable? If acceptable, click ‘Possible,’ and if amendments are needed, enter desired dates in blanks under ‘Amendment.’” This document view differs from those sent to the makers 2B, 3B, 5B, and 6A in the maker name, expected start date, and expected delivery date. The expected start and delivery dates for the makers correspond to the start and end dates of sections in the bar graph for the maker group I6-O6 shown in FIG. 30.

In step S47 of FIG. 13, the maker 4B determines whether or not the expected start and delivery dates are feasible. If the maker 4B can keep the dates, the maker 4B clicks, in step S48, the button “Possible” of FIG. 33 to inform the controller 21 (the platform provider) of the acceptance of the dates through the controller 51. In this example, the maker 4B wants to change the start and delivery dates and enters preferable dates as shown in FIG. 33. The entered dates are informed to the controller 21 through the controller 51.

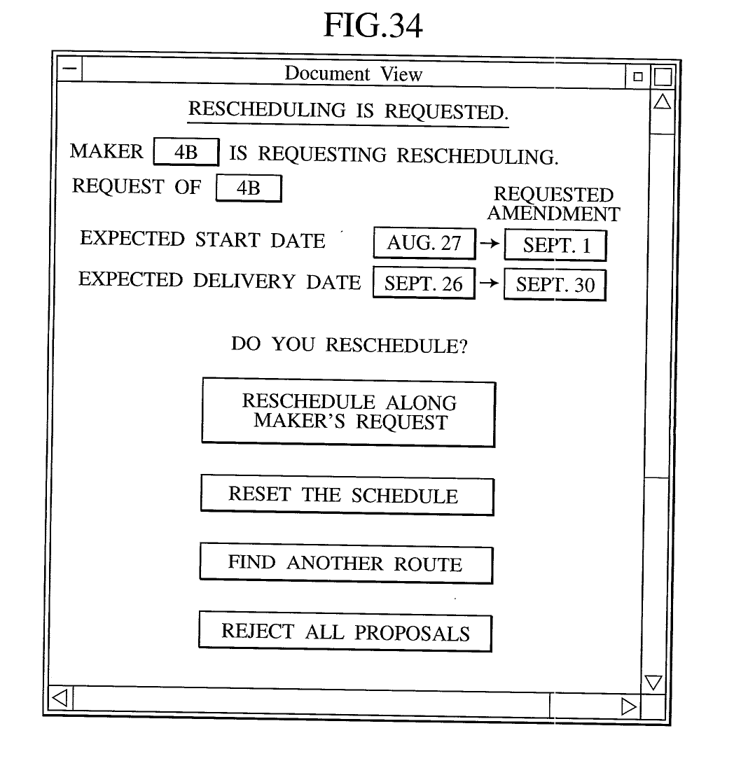

Since the original dates must be adjusted, the controller 21 informs, in step S49 of FIG. 13, the developer's controller 61 of the dates amended by the maker 4B and asks the developer whether the developer reschedules the delivery dates or selects another maker group. The controller 21 instructs the controller 61 of the computer 16 to display a document view of FIG. 34 on the display 66. This document view has a message of “Rescheduling is requested,” the name of the maker who wants to change the delivery dates, desired start and delivery dates, a message of “Do you reschedule?,” a button of “Reschedule along maker's request,” a button of “Reset the schedule” for resetting the expected start and delivery dates stated in FIG. 28, a button of “Find another route,” and a button of “Reject all proposals.”

In step S50 of FIG. 13, the developer pushes one of the buttons “Reschedule along maker's request,” “Reset the schedule,” “Find another route,” and “Reject all proposals.” In this way, the schedule is adjusted among the controller 21 (platform provider), controller 61 (developer), and controllers 51 (makers), to fix a final schedule along which all makers can keep delivery dates.

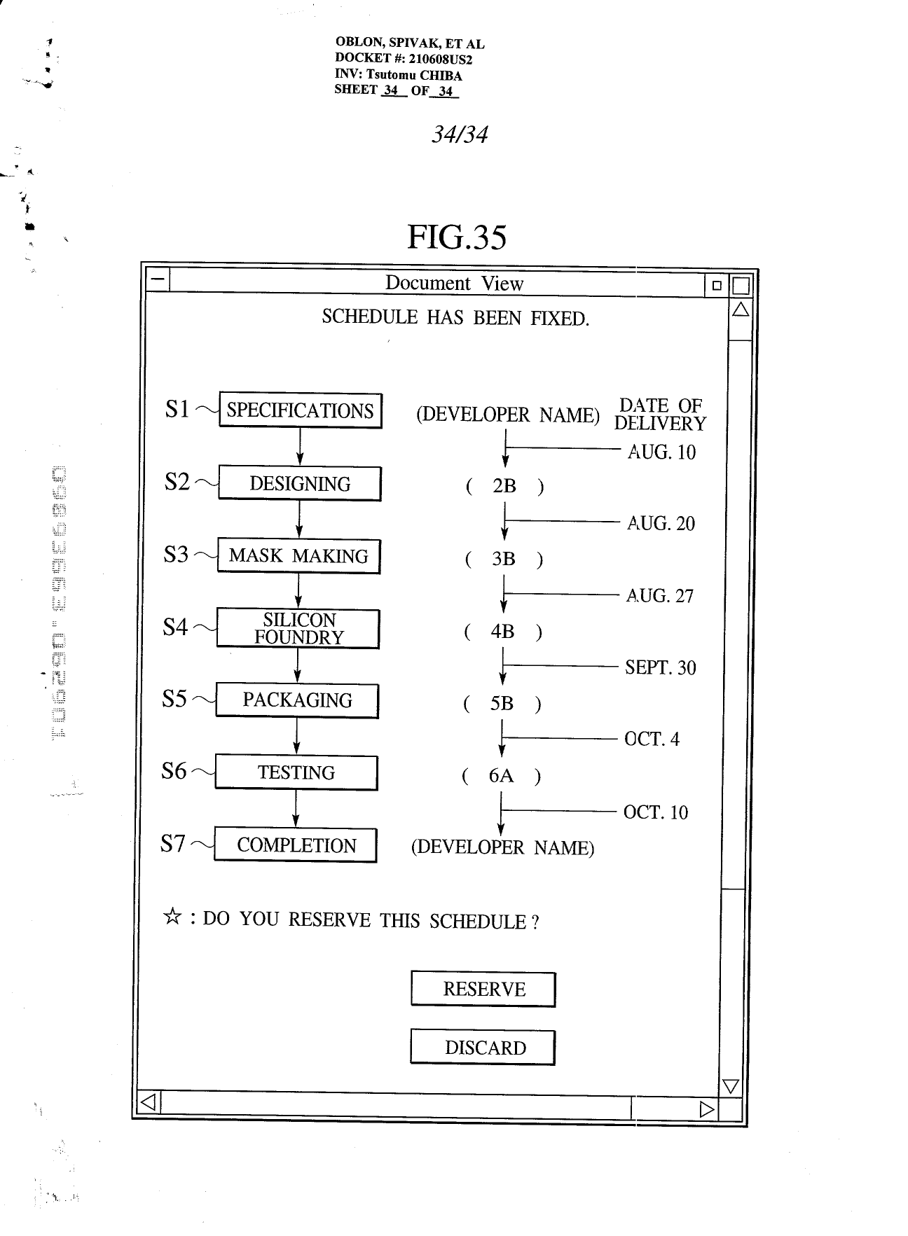

In step S51 of FIG. 13, the controller 21 of the platform provider informs the developer of the settled delivery dates of all makers and prompts the developer to determine whether or not the delivery dates must be reserved. The controller 21 instructs the output controller 23 to display a document view of FIG. 35 on the display of the computer 16 of the developer. This document view has a message of “Schedule has been fixed,” the fixed schedule, a message of “Do you reserve this schedule?,” a button “Reserve,” and a button “Discard.”

In step S52 of FIG. 13, the developer determines whether the schedule must be reserved or abandoned. The determination is transferred to the controller 21. If the schedule must be reserved, the platform provider informs, in step S53, the controllers 51 of the makers including the maker 2B of their delivery dates. If the schedule must be discarded, the platform provider informs, in step S53, the controllers 51 of the makers of the discard of their delivery dates. The controllers 51 display the information on their displays 56.

If the schedule must be reserved, the makers reserve their lines for manufacturing the semiconductor device developed by the developer.

A series of the steps shown in the flowcharts of FIGS. 11 to 13 is recorded as a program in a computer readable storage medium and is executed by a computer. The data structures of FIGS. 8 to 10 containing data used for computer operations are also stored in a computer readable storage medium. The storage medium for the program may include the main program storage 24 of FIG. 3, and the storage medium for the data structures may include the maker file storage 25, interface file storage 26, and developer file storage 27 of FIG. 3. These storage media may be semiconductor memories, magnetic disks, optical disks, and magnetic tapes. The program and data structures stored in the storage media are read by a computer system, to execute procedures written in the program. The computer system has, for example, a floppy disk drive and a CD-ROM drive into which a floppy disk and a CD-ROM storing the program are inserted, respectively. The program is read by and installed in the computer system. The program and data structures may be transferred among computer systems through a transmission system such as the Internet. Each computer system may be connected to drives for handling game pack ROMs and magnetic cassette tapes that act like the semiconductor memories, magnetic disks, optical disks, and magnetic tapes in storing the program.

Various modifications will become possible for those skilled in the art after receiving the teachings of the present disclosure without departing from the scope thereof.

What is claimed is:

1. An apparatus for assisting the placing of an order for manufacturing a semiconductor device, comprising:
means for registering a maker group of interfaced makers, including:
means for organizing a maker group from makers of different categories to manufacture a semiconductor device in collaboration with one another;
means for confirming interfaces among the makers in the organized maker group, the interfaces serving to hand over materials among the makers to complete a semiconductor device; and
means for recording the interface-confirmed maker group; and
means for introducing maker groups of interfaced makers registered through the registering means, including:
means for retrieving maker groups that satisfy specifications set for a given semiconductor device.

2. The apparatus as in claim 1, wherein:
said registering means includes means for inviting makers.

3. The apparatus as in claim 1, wherein:
said introducing means includes means for selecting one of the retrieved maker groups as a maker group to which a manufacturing order is placed.

4. The apparatus as in claim 1, wherein:
said introducing means includes means for assisting specification determination.

5. The apparatus as in claim 1, wherein:
said introducing means includes means for scheduling delivery dates along which makers in one of the retrieved maker groups hand over materials to complete the given semiconductor device.

6. A program for assisting the placing of an order for manufacturing a semiconductor device, comprising:
registering a maker group of interfaced makers, including:
organizing a maker group from makers of different categories to manufacture a semiconductor device in collaboration with one another;
confirming interfaces among the makers in the organized maker group, the interfaces serving to hand over materials among the makers to complete a semiconductor device; and
recording the interface-confirmed maker group; and
introducing maker groups of interfaced makers registered through said registering, including:
retrieving maker groups that satisfy specifications set for a given semiconductor device.

7. The program as in claim 6, wherein:
said registering includes inviting makers.

8. The program as in claim 6, wherein:
said introducing includes selecting one of the retrieved maker groups as a maker group to which a manufacturing order is placed.

9. The program as in claim 6, wherein:
said introducing includes assisting specification determination.

10. The program as in claim 6, wherein:
said introducing includes scheduling delivery dates along which makers in one of the retrieved maker groups hand over materials to complete the given semiconductor device.

11. A data structure usable for assisting the placing of an order for manufacturing a semiconductor device, comprising:
an area to store the names of makers; and
an area related to said area to store the names of makers, to store categories in a one-to-one relationship with the makers.

12. The data structure as in claim 11, further comprising:
an area related to said area to store the names of makers, to store features in a one-to-one relationship with the makers.

13. The data structure as in claim 12, wherein:
the feature of each maker includes the manufacturing capability and accuracy of the maker.

14. The data structure as in claim 12, wherein:
the feature of each maker includes the names of makers with which the maker in question desires to be interfaced and the names of makers with which the maker in question is already interfaced.

15. The data structure as in claim 12, wherein:
the feature of each maker includes a turnaround time needed by the maker to manufacture a semiconductor device and a price charged by the maker to manufacture the semiconductor device.

16. A data structure usable for assisting the placing of an order for manufacturing a semiconductor device, comprising:
an area to store categories of semiconductor device manufacture; and
an area related to said area to store categories, to store the names of makers in a maker group that has manufactured a semiconductor device, in a one-to-one relationship with the categories.

17. The data structure as in claim 16, further comprising:
an area related to said area to store the names of makers, to store manufacturing capability indexes of each maker in a one-to-one relationship with the names of makers.

18. The data structure as in claim 17, wherein:
the manufacturing capability indexes of each maker include a turnaround time needed by the maker to manufacture a semiconductor device and a price charged by the maker to manufacture the semiconductor device.

19. A method of assisting the placing of an order for manufacturing a semiconductor device, comprising:
registering a maker group of interfaced makers, including:
organizing a maker group from makers of different categories to manufacture a semiconductor device in collaboration with one another;
confirming interfaces among the makers in the organized maker group, the interfaces serving to hand over materials among the makers to complete a semiconductor device; and
recording the interface-confirmed maker group; and
introducing maker groups of interfaced makers registered through the registering, including:
retrieving maker groups that satisfy specifications set for a given semiconductor device.

20. The method as in claim 19, wherein:
said registering a maker group includes inviting makers.

21. The method as in claim 19, wherein:
said introducing maker groups includes selecting one of the retrieved maker groups as a maker group to which a manufacturing order is placed.

22. The method as in claim 19, wherein:
said introducing maker groups includes assisting specification determination.

23. The method as in claim 19, wherein:
said introducing maker groups includes scheduling delivery dates along which makers in one of the retrieved maker groups hand over materials to complete the given semiconductor device.
